(19) United States
(12) Patent Application Publication
(10) Pub. No.: US 2010/0304236 A1
(43) Pub. Date: Dec. 2, 2010

(54) CATALYSTS AND METHODS INCLUDING STEAM REFORMING

(75) Inventors: Jackie Y. Ying, Connexis (SG); Hong He, Schenectady, NY (US)

Correspondence Address: WOLF GREENFIELD & SACKS, P.C., 600 ATLANTIC AVENUE, BOSTON, MA, 02210-2206, US

(73) Assignee: MASSACHUSETTS INSTITUTE OF TECHNOLOGY, CAMBRIDGE, MA (US)

(21) Appl. No.: 12/529,033

(22) PCT Filed: Feb. 28, 2008
(86) PCT No.: PCT/US08/02642

§ 371 Date: May 7, 2010

Related U.S. Application Data
(60) Provisional application No. 60/903,893, filed on Feb. 28, 2007.

(51) Int. Cl. H01M 8/06; B01J 35/00; C01B 3/26

(52) U.S. Cl. 429/423; 422/162; 423/654

(57) ABSTRACT

The present invention generally relates to catalyst compositions comprising aluminates, such as nickel aluminates, and related methods. In some embodiments, the catalyst composition may be advantageously modified, for example, by the addition of one or more metal additives to further enhance catalyst performance. Such modifications can provide a more effective catalyst and can reduce the level of coking during catalytic processes. Some embodiments of the invention may provide effective catalyst compositions for steam reforming. In some cases, the catalyst composition may be utilized under relatively mild reaction conditions.

### STATEMENT REGARDING FEDERALLY SPONSORED RESEARCH OR DEVELOPMENT

This invention was made with the support under the following government contract: DAAD-01-1-0566 awarded by the U.S. Army Research Office. The government has certain rights in the invention.

### FIELD OF THE INVENTION

The present invention provides catalyst compositions, methods, and systems for processes including steam reforming.

### BACKGROUND OF THE INVENTION

Hydrogen is widely used as a feedstock in chemical manufacturing processes. It also has increasing appeal as a clean fuel as challenges from fossil fuel shortage and environmental pollution increase. Hydrogen may be particularly attractive as a feedstock for fuel cell systems. Due to the difficulty of hydrogen storage, various on-board hydrogen production processes that make use of a more easily stored fuel, such as propane for example, have been investigated. Steam reforming may be of particular interest for hydrogen production in industrial processes since it can provide higher hydrogen concentration compared to partial oxidation and autothermal reforming, and is relatively cost effective.

While NiO/Al₂O₃ is a widely used industrial catalyst for steam reforming as it is active and economical, it also exhibits only some resistance against coking. Coke deposition on catalysts surface may significantly increase the pressure drop of the catalyst bed and may deactivate the catalyst system. To improve coke resistance, other nickel-containing catalysts have been employed, and have been shown to exhibit improved excellent catalytic activity and coking resistance when applied to the steam reforming of methane. However, such catalysts have shown lower reducibility compared to NiO/Al₂O₃.

Accordingly, improved methods are needed.

### SUMMARY OF THE INVENTION

The present invention provides catalyst compositions, methods, and systems for steam reforming.

The present invention relates to catalyst systems for steam reforming, comprising a reaction chamber constructed and arranged to be exposed to a source of reactant gas, the reaction chamber comprising a catalyst composition for catalyzing a reaction involving the reactant gas, the catalyst composition comprising a nickel aluminate material and a metal additive, wherein the ratio of nickel to metal additive is greater than 2.5:1, by weight.

The present invention also relates to catalyst systems for steam reforming, comprising a reaction chamber constructed and arranged to be exposed to a source of reactant gas, the reaction chamber comprising a catalyst composition for catalyzing a reaction involving the reactant gas, the catalyst composition comprising a nickel aluminate material and a metal additive, wherein the molar ratio of nickel to aluminum is greater than 0.96:1.

The present invention also provides methods comprising contacting a reactant gas with a catalyst composition comprising a nickel aluminate material, wherein the contacting takes place at less than 500° C.; and allowing the reactant gas to undergo a chemical reaction with the catalytic material to produce a desired product, wherein at least 75.0% of the reactant gas undergoes the chemical reaction.

The present invention also provides methods comprising contacting a reactant gas with a catalyst composition comprising a nickel aluminate material and a metal additive, wherein the ratio of nickel to metal additive is greater than 2.5:1, by weight, or, wherein the molar ratio of nickel to aluminum is greater than 0.96:1; and allowing the reactant gas to undergo a chemical reaction with the catalytic material to produce a desired product.

### BRIEF DESCRIPTION OF THE DRAWINGS

FIG. 1 shows a schematic diagram of a packed bed reactor set-up.

FIG. 2 shows a graph of propane conversion over nickel aluminates with Ni/Al ratios of (a) 0.25:1, (b) 0.50:1, (c) 0.75:1, (d) 1.00:1, (e) 1.10:1, (f) 1.50:1 and (g) 2.00:1, and (h) NiO/Al₂O₃ mixture (molar ratio=1.1:0.5), after calcination at 700° C. in air. Catalytic testing was performed with a feed of 10% C₃H₈ in N₂ and H₂O at 70,000 h⁻¹ and H₂O/C=2.

FIG. 3 shows the plot of the (a) Specific and (b) intrinsic reaction rates of nickel aluminates with various Ni/Al ratios in propane steam reforming. Reaction rates were obtained under differential conversions at 280° C. with a feed of 10% C₃H₈ in N₂ and H₂O at 70,000 h⁻¹ and H₂O/C=2.

FIG. 4 shows the plot of (a) H₂ yield, selectivities for (b) CH₄, (c) CO and (d) CO₂, and (e) C₃H₈ conversion over nickel aluminates with various Ni/Al ratios in propane steam reforming at 600° C. Catalytic testing was performed with a feed of 10% C₃H₈ in N₂ and H₂O at 70,000 h⁻¹ and H₂O/C=2:1.

FIG. 5 shows the propane conversion over nickel aluminate with Ni/Al=1.10 after calcination at (a) 500° C., (b) 600° C., (c) 700° C., (d) 800° C. and (e) 900° C. Catalylic testing was performed with a feed of 10% C₃H₈ in N₂ and H₂O at 70,000 h⁻¹ and H₂O/C=2.

FIG. 6 shows a plot of the (a) H₂ yield, selectivities for (b) CH₄, (c) CO and (d) CO₂, and (e) C₃H₈ conversion over nickel aluminate with Ni/Al=1.10 in propane steam reforming at the reaction temperatures specified. Catalytic testing was performed with a feed of 10% C₃H₈ in N₂ and H₂O at 70,000 h⁻¹ and H₂O/C=2.

FIG. 7 shows a plot of the (a) H₂ yield, selectivities for (b) CH₄, (c) CO and (d) CO₂, and (e) C₃H₈ conversion over nickel aluminate with Ni/Al=1.10 in propane steam reforming at 600° C. Catalytic testing was performed with a feed of 10% C₃H₈ in N₂ and H₂O at 70,000 h⁻¹ and the H₂O/C ratio specified.

FIG. 8 shows a plot of the coking rate over nickel aluminate with Ni/Al=1.10 in propane steam reforming at 600° C. for. Catalytic testing was performed with a feed of 10% C₃H₈ in N₂ and H₂O at 70,000 h⁻¹ and the H₂O/C ratio specified.

FIG. 9 shows (a) the STEM/EDX image and elemental maps of 700° C-calcined nickel aluminate with Ni/Al=1.10, after reaction at 600° C. Maps for (b) Al, (c) O, (d) Ni, and (e) C are shown. Catalytic testing was performed with a feed of 10% C₃H₈ in N₂ and H₂O at 70,000 h⁻¹ and H₂O/C=2.

FIG. 10 shows the TEM images of nickel aluminate with Ni/Al=1.10 (a) before and (b) after reaction at 600° C. Catalytic testing was performed with a feed of 10% C₃H₈ in N₂ and H₂O at 70,000 h⁻¹ and H₂O/C=1.

FIG. 11 shows a graph of the (a) light-off temperature in propane steam reforming and (b) active surface area of nickel aluminate with Ni/Al=1.10 and 1 wt % of the promoter specified, after calcination at 700° C. in air. Catalytic testing was performed with a feed of 10% C₃H₈ in N₂ and H₂O at 70,000 h⁻¹ and H₂O/C=2.

FIG. 12 shows a graph of the (a) light-off temperature in propane steam reforming and (b) active surface area of nickel aluminate with Ni/Al=1.10 and 1 wt % of the promoter specified, after calcination at 700° C. in air. Catalytic testing was performed with a feed of 10% C₃H₈ in N₂ and H₂O at 70,000 h⁻¹ and H₂O/C=2.

FIG. 13 shows a graph of the light-off temperature in propane steam reforming over nickel aluminate with Ni/Al=1.10 and 1 wt % of the promoter specified, after calcination at 700° C. in air. Catalytic testing was performed with a feed of 10% C₃H₈ in N₂ and H₂O at 70,000 h⁻¹ and H₂O/C=2.

FIG. 14 shows a graph of the active surface area of nickel aluminate with Ni/Al=1.10 and 1 wt % of the promoter specified, after calcination at 600° C. in air.

FIG. 15 shows a graph of the coking rate over nickel aluminate with Ni/A1=1.10 and 1 wt % of the promoter specified. Propane steam reforming was performed with a feed of 10% C₃H₈ in N₂ and H₂O at 600° C., 70,000 h⁻¹ and H₂O/C=2.

FIG. 16 shows a graph of the propane conversion over nickel aluminate with Ni/Al=1.10 and (a) 0, (b) 0.5, (c) 1, (d) 2, (e) 3, (f) 4 and (g) 5 wt % of Re, after calcination at 600° C. in air. Catalytic testing was performed with a feed of 10% C₃H₈ in N₂ and H₂O at 70,000 h⁻¹ and H₂O/C=2.

FIG. 17 shows a graph of the (a) H₂ yield, and selectivities for (b) CH₄, (c) CO and (d) CO₂, and (e) C₃H₈ conversion over nickel aluminate with Ni/Al=1.10 and the Re loading specified. Propane steam reforming was performed with a feed of 10% C₃H₈ in N₂ and H₂O at 500° C., 70,000 h⁻¹ and H₂O/C=2.

FIG. 18 shows a graph of the (a) H₂, (b) CH₄, (c) CO, (d) CO₂ and (e) C₃H₈ composition in the product stream of propane steam reforming over nickel aluminate (Ni/Al=1.10) with no promoter or 1 wt % of Re. Catalytic testing was performed with a feed of 10% C₃H₈ in N₂ and H₂O at the temperature specified, 70,000 h⁻¹ and H₂O/C=2.

FIG. 19 shows a graph of the coking rate over nickel aluminate (Ni/Al=1.10) with (a) no promoter and (b) 1 wt % of Re. Propane steam reforming was performed with a feed of 10% C₃H₈ in N₂ and H₂O at 500° C., 70,000 h⁻¹ and the H₂O/C ratio specified.

FIG. 20 shows the H₂ yield as a function of H₂O/C ratio in propane steam reforming over nickel aluminate catalyst (Ni/Al=1.10) with (i) no promoter, (ii) 1 wt % Re, (iii) 3 wt % V, and (iv) 2 wt % Re+2 wt % V. The solid lines represent equilibrium calculation results. Catalytic testing was performed with a feed of 10% C₃H₈ in N₂ and H₂O at (a) 400° C., (b) 500° C., (c) 600° C. and (d) 700° C. and 70,000 h⁻¹.

FIG. 21 shows a graph of the coking rate over nickel aluminate (Ni/Al=1.10) with (a) no promoter and (b) 3 wt % of V in propane steam reforming at the temperature specified. Catalytic testing was performed with a feed of 10% C₃H₈ in N₂ and H₂O at 70,000 h⁻¹ and H₂O/C=1.

FIG. 22 shows the () H₂, ( [symbol] ) CH₄, ( [symbol] ) CO and ( [symbol] ) CO₂ composition in the product stream of propane steam reforming over nickel aluminate (Ni/Al=1.10) with no promoter or 2 wt % Re+2 wt % V. Catalytic testing was performed with a feed of 10% C₃H₈ in N₂ and H₂O at the temperature specified, 70,000 h⁻¹ and H₂O/C=1.

FIG. 23 shows a graph of the coking rate over nickel aluminate (Ni/Al=1.10) with (a) no promoter and (b) 2 wt % Re+2 wt % V in propane steam reforming at the temperature specified. Catalytic testing was performed with a feed of 10% C₃H₈ in N₂ and H₂O at 70,000 h⁻¹ and H₂O/C=1.

FIG. 24(a) shows STEM/EDX images and elemental maps of 2 wt % Re,2 wt % V-promoted nickel aluminate (i) after reduction at 650° C. for (ii) Al, (iii) O, (iv) Ni, (v) Re, and (vi) V. FIG. 21(b) shows STEM/EDX images and elemental maps of 2wt % Re, 2wt % V-promoted nickel aluminate (i) after reaction at 600° C. for (ii) Al, (iii) O, (iv) Ni, (v) Re, (vi) V, and (vii) C. Catalytic testing was performed with a feed of 10% C₃H₈ in N₂ and H₂O at 70,000 h⁻¹ and H₂O/C=1.

FIG. 25 shows the TEM images of 2 wt % Re,2 wt % V-promoted nickel aluminate (Ni/Al=1.10) (a) before and (b) after propane steam reforming at 600° C. Catalytic testing was performed with a feed of 10% C₃H₈ in N₂ and H₂O at 70,000 h⁻¹ and H₂O/C=1.

FIG. 26 shows a graph of the coke remaining on nickel aluminate (Ni/Al=1.10) with (a) no promoter, (b) 1 wt % Re and (c) 2 wt % Re+2 wt % V, after coke gasification with the specified concentration of H₂O in N₂ at 100° C-800° C.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

The present invention generally relates to catalyst compositions comprising aluminates, such as nickel aluminates, and related methods.

In general, the invention involves the selection of various components, and amounts thereof, of catalyst composition to improve catalyst performance in processes including steam reforming. In some embodiments, the catalyst composition may be advantageously modified, for example, by the addition of one or more additives to further enhance catalyst performance. For example, some embodiments of the invention involve the discovery that formation of a catalyst comprising metal additives in relatively small quantities can provide a particularly effective steam reforming catalyst. Such modifications can provide a more effective catalyst and can reduce the level of coking during catalytic processes. In some cases, the catalyst composition may be utilized under relatively mild reaction conditions.

The present invention may be advantageous in that materials described herein may substantially reduce undesirable side reactions at high temperatures that may diminish the performance of the materials, for example, in catalyst applications or in fuel cells. In some cases, the present invention may provide materials and methods that substantially reduce the level of coking on the surface of the catalyst. As used herein, the term “coking” refers to the high-temperature formation of carbon, such as pyrolytic, encapsulating, or whisker coke, on metal surfaces, as described more fully below. In some embodiments, the ability to suppress the level of coking may be particularly advantageous for catalytic processes such as steam reforming. For example, coke formation may damage the mechanical structure of a catalyst composition in high-temperature applications (e.g., fuel cells, catalysts), as well as reduce the activity of the catalyst composition. However, catalyst compositions of the present invention may retain sufficient activity, even upon exposure to carburizing environments at high temperatures. In some embodiments, catalyst compositions of the present invention may retain sufficient catalytic activity at high temperatures for the production of hydrogen gas.

The present invention may also provide compositions and methods which may be effective under relatively mild conditions. In some cases, the present invention provides catalyst compositions exhibiting increased catalytic activity at lower temperatures, when compared to known catalyst systems. For example, some catalyst systems may require high temperatures in order to generate the catalytically active species and/or perform a catalytic reaction. By contrast, catalyst compositions and systems of the present invention may be activated (e.g., may produce the catalytically reactive species) or may catalyze a chemical process using relatively low temperatures, such as temperatures below 500° C.

In some embodiments, the present invention provides catalyst compositions comprising metal atoms for catalytic processes, such as steam reforming. The metal may be capable of performing a reaction including oxidation and/or reduction. As used herein, a “catalyst composition” refers to any material capable of serving as a catalyst in a chemical reaction. The catalyst composition may comprise a metal, compound (e.g., metal-containing compound), atom, or mixtures thereof. In some cases, catalyst compositions of the invention may comprise aluminate materials, such as a nickel aluminate material. As used herein, a “nickel aluminate material” includes any material comprising nickel, aluminum, and oxygen atoms. Typically, a nickel aluminate material comprises an anionic species comprising aluminum, such as AlO₂⁻, Al₂O₄²⁻, or AlO₃³⁻. For example, NiAl₂O₄ is an example of a nickel aluminate material. In some cases, nickel may be a catalytically active species in steam reforming.

Some catalyst compositions of the invention may be selected to comprise an amount of nickel atoms which provides improved catalyst performance. For example, nickel aluminate materials may advantageously comprise nickel atoms dispersed throughout the nickel aluminate material. This may increase the surface area comprising nickel (e.g, the active surface area), such that a large amount of nickel atoms may be primarily positioned in an exposed state at the surface of the catalyst composition, maximizing contact with a reactant gas or fluid. In some cases, the presence of large amounts of nickel within the catalyst composition may result in the formation of a NiO phase, in addition to the nickel aluminate phase (e.g., NiAl₂O₄). In some cases, the presence of a NiO phase in the catalyst composition may advantageously lower the temperature at which the catalyst composition is activated (e.g., reduced). Thus, the catalyst composition may be selected to comprise a large amount of nickel atoms relative to other components of the composition.

The present invention may provide nickel aluminate materials comprising various molar ratios of Ni/Al. For example, the catalyst composition may have a Ni/Al molar ratio greater than 0.96:1, greater than 1.0:1, greater than 1.2:1, greater than 1.4:1, greater than 1.6:1, greater than 1.8:1, or, in some cases, greater than 2.0:1. Nickel aluminate materials may comprise one or more phases, as determined by X-ray diffraction (XRD). Those of ordinary skill in the art would be able to synthesize materials with varying Ni/Al molar ratios, using methods such as co-precipitation or other chemical methods. Characterization of such materials may be performed using methods such as X-ray diffraction and BET surface area measurements. The selection of Ni/Al molar ratio may determine the number and type of phases present in the material. For example, the material may comprise a NiO phase, a NiAl₂O₄ phase, or combinations thereof, as determined by XRD. In some cases, nickel aluminate materials having a Ni/Al of 0.75 or greater may comprise both a NiO phase and a NiAl₂O₄ phase.

In some cases, catalyst compositions of the invention may advantageously comprise a metal additive or metal promoter. As used herein, a “metal additive” may be any metal capable of enhancing the performance of the catalyst composition, for example, by increasing the activity of the catalyst composition and/or by reducing the formation of coke on the surface of the catalyst composition at elevated temperatures. Modification of catalyst compositions with at least one metal additive may also increase the active surface area of the catalyst composition. In some cases, the metal additive may be a transition metal. For example, the metal additive may be Re, V, Rh, Pt, Ir, Pd, Fe, La, Co, Mn, Os, Sr, Ce, Ta, Mo, Cr, Au, Sm, Nb, Cu, W, Sn, Ag, or a combination thereof. In some embodiments, the metal additive may be Re, V, Rh, Pt, Ir, Pd, Fe, La, Co, Mn, Os, Sr, Ce, or a combination thereof. In some embodiments, the metal additive may be Re, V, Rh, Pt, Ir, Pd, or a combination thereof. In some embodiments, the metal additive is Re. In some embodiments, the metal additive is V. In some embodiments, the metal comprises Re and V. In one set of embodiments, the metal additive is not Ru.

In some cases, the catalyst composition advantageously comprises a small amount of metal additive relative to the amount of nickel, i.e., the catalyst composition may comprise a relatively large amount of nickel. For example, the catalyst composition may comprise a small amount of metal additive dispersed within the catalyst composition and/or on the surface of the catalyst composition. Metal additives may be present in a sufficiently small amount such that the three-dimensional structure of the base catalyst composition remains substantially the same. For example, a catalyst composition lacking a metal additive (e.g., a base catalyst composition) may exhibit a first X-ray diffraction pattern, while a catalyst composition comprising a metal additive as described herein may exhibit a second X-ray diffraction pattern that is substantially similar to the first X-ray diffraction pattern. That is, the first and second X-ray diffraction patterns may exhibit the same number of peaks at essentially the same relative locations (e.g., periodicities) and may exhibit substantially similar peak intensities. In other words, the lattice structure of a catalyst composition lacking a metal additive may not be substantially changed upon addition of a metal additive to the catalyst composition, as described herein. In some cases, the ratio of nickel to metal additive may be greater than 5.0:1 greater than 10.0:1, greater than 25.0:1, 50.0:1, or, in some cases, greater than 100:1, by weight. In some embodiments, the nickel aluminate material has a nickel to aluminum molar ratio of 1.1:1.

In some cases, catalyst compositions of the invention may comprise metal additives in a sufficiently small amount such that the composition does not form an alloy or an intermetallic compound. The term “alloy” is given its ordinary meaning in the art, and refers to a combination of two or more elements, wherein at least one element is a metal, and wherein the resulting material has metallic properties. As used herein, the term “intermetallic compound” is given its ordinary meaning in the art, and refers to a material (e.g., chemical compound) formed between two or more metals and/or a metal and nonmetal, wherein the material comprises a crystal structure that is different from those of the constituents.

The present invention also provides catalyst systems comprising catalyst compositions as described herein. In a set of embodiments, catalyst systems of the present invention include a reaction chamber. As used herein, a “reaction chamber” refers to an apparatus within which the steam reforming may take place. The reaction chamber may be constructed and arranged to be exposed to a source of a reactant gas such that the reactant gas to may be processed, for example, by steam reforming, to form hydrogen. In some embodiments, the reaction chamber may comprise catalyst compositions as described herein positioned within the reaction chamber which may be exposed to the source of the reactant gas. Examples of reaction chambers include, but are not limited to, fuel cell systems, sensors, other chemical systems comprising steam reforming catalysts, and the like. As used herein; a system “constructed and arranged to be exposed to a source of a reactant gas” is a term that would be understood by those of ordinary skill in the art, and is given its ordinary meaning in this context and, for example, refers to a system provided in a manner to direct the passage of a fluid, such as a fluid that is or that includes a hydrocarbon, over the catalyst composition positioned within the reaction chamber. The “source of a reactant gas” may include any apparatus comprising a reactant gas, any apparatus or material that may be used to produce a reactant gas, and the like. A “reactant gas” as used herein refers to a gas or mixture of gases that may include a hydrocarbon (e.g., methane, propane, etc.) and/or other components, including water. The reactant gas may also comprise other fluids, including alcohols, such as methanol or ethanol, or other organic and/or aqueous fluids. In some cases, the reactant gas may be provided by vaporization of a liquid or a mixture of liquids.

Another aspect of the present invention provides methods for catalytic processes. In some cases, catalyst compositions s of the invention may be useful in high-temperature reactions that may be susceptible to coke formation, such as steam reforming. As used herein, the term “steam reforming” is given its ordinary meaning in the art and refers to the process of reacting a hydrocarbon with a metal catalyst in the presence of water to produce hydrogen and carbon monoxide (CO). Generally, the catalyst composition may be treated (e.g., reduced) prior to exposure to a reactant gas to produce Ni metal, which may serve as a catalytically active species involved in the reaction. After use in the catalytic reaction, the catalyst composition may be readily regenerated (e.g., oxidized) upon exposure to air.

In some cases, the method may comprise contacting a reactant gas with a catalyst composition as described herein, and allowing the reactant gas to undergo a chemical reaction with the catalyst composition to produce a desired product. For example, a reactant gas such as propane may contact a catalyst composition as described herein, wherein a chemical reaction takes place to produce hydrogen gas. Without wishing to be bound by theory, the mechanism of steam reforming over metal catalysts may involve the adsorption of a hydrocarbon onto the catalyst surface, resulting in CHₓ species, which may then undergo extraction of hydrogen atoms to produce H₂. Additionally, hydrogen adsorbed on the catalyst surface may react with the CHₓ species to produce methane. Also, CO may react with H₂O to further produce CO₂, producing additional hydrogen.

The method may further comprise contacting the catalyst composition with water in combination with the reactant gas. In some cases, water and a hydrocarbon may be introduced to the catalyst system, wherein the H₂O/C ratio is 1.0:1 or greater, 1.5:1 or greater, 2.0:1 or greater, or, in some cases, 5.0:1 or greater. The relative amounts of water and reactant gas introduced into catalyst systems of the invention may affect the catalytic reaction. For example, steam reforming of propane using a nickel aluminate catalyst composition having a Ni/Al molar ratio of 1.10:1 may achieve complete conversion of propane at a H₂O/C ratio of 1.0:1. In some cases, the introduction of increased amounts of water may enhance oxidation of hydrocarbons. In some cases, higher ratios of H₂O/C may increase CO₂ formation and/or decrease CO formation. In some cases, the amount of hydrogen may increase with increasing H₂O/C ratio.

In methods of the invention, a majority of the reactant gas may be converted into one or more products via a chemical reaction catalyzed by the catalyst composition. In some cases, at least 75%, at least 80.0%, at least 85.0%, at least 90.0%, at least 95.0%, at least 97.0%, of the reactant gas may undergo the chemical reaction. In some cases, substantially all of the reactant gas may undergo the chemical reaction (e.g., 100%).

When exposed to a reactant gas, catalyst systems of the present invention may perform catalytic oxidation of a hydrocarbon to produce hydrogen at relatively lower temperatures than known catalysts, which often require temperatures of 500° C. or higher. In the present invention, methods are provided for the catalytic oxidation of a hydrocarbon at relatively lower temperatures (e.g., below 500° C.). For example, at least 75.0% of the reactant gas may undergo the chemical reaction upon exposure of the catalyst composition to the reactant gas at temperatures less than 500° C., less than 480° C., less than 460° C., less than 440° C., or, in some cases, less than 420° C. In some cases, at least 75.0% of the reactant gas may undergo the chemical reaction upon exposure of the catalyst composition to the reactant gas at at least 400° C. The ability to conduct steam reforming processes at lower temperatures may advantageously provide simplified methods for the production of, for example, hydrogen gas.

It should also be understood that the catalyst compositions and systems may be useful for reactions conducted at temperatures greater than 500° C. In some embodiments, a reaction employed catalyst compositions of the invention may be performed at greater than 600° C.; or greater than 700° C.; or, greater than 800° C., or greater than 900° C. In some cases, o substantially all of the reactant gas (e.g., 100%) may be converted to one or more products at temperatures greater than 500° C.

In one embodiment, a catalyst composition comprising a nickel aluminate and Re as a metal additive may exhibit increased catalytic activity when compared to an essentially identical catalyst composition lacking the metal additive, under essentially identical conditions. In another embodiment, a catalyst composition comprising a nickel aluminate and V, Mo, or W as a metal additive may exhibit decreased coke formation when compared to an essentially identical catalyst composition lacking the metal additive, under essentially identical conditions. In another embodiment, a catalyst composition comprising a nickel aluminate, Re as a first metal additive, and V as a second metal additive may exhibit high catalytic activity, increased H₂ yield, and decreased coke formation, when compared to an essentially identical catalyst composition lacking metal additives, under essentially identical conditions.

The use of catalyst compositions in steam reforming applications is described herein by way of example only. It should be understood catalyst compositions of the present invention may be useful as catalysts for other processes including dry reforming, steam reforming, cracking, dehydrogenation, methane coupling, oxidation of hydrocarbons, conversion of synthesis gas, production of synthesis gas, and the like. The catalyst compositions may also be used in other catalytic applications at both high temperatures and low temperatures. In some cases, the metal additives may be incorporated into the catalyst composition using methods known in the art, such as wet impregnation or vapor grafting. Metal additive precursors, such as metals, alloys, oxides, mixed oxides, sulfides, organometallic compounds, inorganic salts, and the like, may be employed to form the metal additive. Those of ordinary skill in the art would be able to select combinations of such metal additive precursors to form catalyst compositions as described herein without undue experimentation.

Catalyst compositions of the present invention may employ additional dopants and/or promoters, as known to those of ordinary skill in the art, in addition to the metal additives described herein. For example, the catalyst compositions may comprise additional components to improve textural properties, sulfur tolerance, and/or stability of the catalyst compositions. In some cases, the catalyst system may further comprise a support material associated with the catalyst composition. For example, a support material such as a ceramic or other material may be used to form or to modify at least a portion of any of the above-described catalyst compositions. Examples of suitable support materials include ceramic or metallic supports, or combinations thereof, such as alumina, ceria, cordierite, mullite, titania, lanthania, heryllia, thoria, silica, magnesia, niobia, vanadia, zirconia, magnesium-stabilized zirconia, zirconia-stabilized alumina, yttrium-stabilized zirconia, calcium-stabilized zirconia, calcium oxide, other ceramics, other materials with low thermal expansion coefficients, and the like.

In some cases, the support material may be a porous material. As used herein, a “porous” material refers to any material having a sufficient number of pores or interstices such that the material is easily crossed or permeated by, for example, a reactant gas. In the present invention, a porous material may advantageously facilitate the diffusion of reactant gases to the catalyst composition. For example, the use of porous material may enhance fuel cell performance by providing access for the fluids to the bottom layer of a fuel cell in a stacked configuration of layers. In one embodiment, the porous material may be chemically inert to the reactant. In another embodiment, the porous material is chemically active to the fuel (e.g., can perform a reduction and/or an oxidation, or can transport either positively or negatively charged ions or both between two electrodes).

As suitable, the catalysts employed in the present invention may involve the use of metals or metal additives which can mediate oxidative processes (e.g., steam reforming) as defined above. In general, any transition metal (e.g., having d electrons) may be used to form the catalyst, e.g., a metal selected from one of Groups 3-12 of the periodic table or from the lanthanide series. However, in preferred embodiments, the metal will be selected from Groups 8-12, more preferably Groups 9-11, and even more preferably Group 10. According to the conventions used herein, the term “Group 9” refers to the transition metal group comprising cobalt, rhodium, and iridium, the term “Group 10” refers to the transition metal group comprising nickel, palladium, and platinum, etc. For example, suitable metals include, but are not limited to, cobalt, rhodium, iridium, nickel, palladium, platinum, copper, silver, or gold, more preferably nickel, palladium, or platinum. It is expected that these catalysts will perform similarly because they are known to undergo similar reactions which are thought to be involved in the formation of the reaction products of the present invention, such as formation of hydrogen. However, the different catalyst compositions are thought to modify the catalyst performance by, for example, modifying reactivity and preventing undesirable side reactions, such as coking. In a particular embodiment, the catalyst comprises nickel.

As described herein, some embodiments of the invention may comprise aluminate materials. As used herein, an “aluminate material” includes any material including an anionic species comprising aluminum and oxygen atoms. Typically, an aluminate material comprises an anion, such as AlO₂⁻, Al₂O₄²⁻, or AlO₃³⁻, and a cationic metal species. The cationic metal species may be any metal, such as an alkali metal, transition metal, lanthanide metal, or the like. For example, a “nickel aluminate material” refers to an aluminate material comprising nickel as the cationic metal species.

The reactant gas may be any fluid capable of interacting (e.g., reacting) with catalyst compositions as described herein to produce a desired product. For example, in some cases, the reactant gas may comprise a hydrocarbon. As used herein, the term “hydrocarbon” includes alkanes, alkenes, alkynes, aromatics, and combinations thereof, including fuels. Some examples of hydrocarbons include methane, ethane, propane, butane, and isooctane. In some cases, reactant gas is methane or propane. In one embodiments, the reactant gas is propane. In other embodiments, the reactant gas may be methanol or ethanol.

The catalyst compositions and systems as described herein may be useful in many applications, including hydrogen generation for various industrial applications and fuel cell devices. In one embodiment, the present invention provides a fuel cell comprising a catalyst system as described herein.

### Examples

### Example 1

### Catalyst Synthesis

Nanocrystalline nickel aluminates with various Ni/Al molar ratios were synthesized by wet-chemical precipitation. Nickel (II) nitrate (Ni(NO₃)₂.6H₂O, 99.9985%, Alfa Aesar) and aluminum nitrate (Al(NO₃)₃.9H₂O, 98-102%, Alfa Aesar) were dissolved in deionized water in a desired molar ratio. A solution of ammonium hydroxide (NH₄OH, 28-30% NH₃, Alfa Aesar) and deionized water (at a volume ratio of 1:4) was used as the base solution. The base solution was added dropwise to the nitrate precursor solution to reach a pH of 8. The resulting suspension was heated to 45° C. and aged for 24 h under stirring. Studies have shown that the precipitation temperature was critical towards obtaining the desired phase of NiAl₂O₄, while longer aging time resulted in relatively low surface area. The precipitate was recovered by filtration, and washed with deionized water and ethanol. After drying at 110° C. for 18 h, the powder was ground with a mortar-and-pestle, and sieved to 230 mesh. The resulting material was calcined at temperatures ranging from 500° C. to 900° C. for 4 h. Stoichiometric (Ni/Al=0.5), Ni-poor (Ni/Al<0.5) and Ni-rich (Ni/Al>0.5) systems were prepared. The Ni and Al contents were analyzed by inductively coupled plasma-atomic to emission spectrometry (ICP-AES) (Desert Analytics, Tucson, Ariz.).

Nanocrystalline nickel aluminates with various metal additives or metal promoters were also synthesized. The metal promoters were introduced onto the nickel aluminate with Ni/Al=1.10 by wet impregnation. In the illustrative embodiments described below, Sr(NO₃)₂, VCl₃, NbCl₅, TaCl₅, Cr(NO₃)₃.9H₂O, (NH₄)₆Mo₇O₂₄, WCl₆, Mn(NO₃)₃, NH₄ReO₄, Fe(NO₃)₃.9H₂O, RuCl₃, OsCl₃, Co(NO₃)₂.6H₂O, Rh(NO₃)₃.2H₂O, IrCl₃.3H₂O, Pd(NO₃)₂, H₂PtCl₆, Cu(NO₃)₂.3H₂O, AgNO₃, AuCl₃, SnCl₂, SnCl₄.3H₂O, La(NO₃)₃.6H₂O, Ce(NO₃)₃. 6H₂O, and Sm(NO₃)₃. 6H₂O (Alfa Aesar) were used as precursors for various metal promoters. Typically, 100 mg of nanocrystalline nickel aluminate with Ni/Al=1.10 were first dispersed in 200 mL of deionized water with stirring. The desired amount of metal promoter precursor was dissolved in a small amount of deionized water, and introduced to the nickel aluminate suspension. The impregnated system was heated to 50° C., and aged for 24 h. After drying at 110° C. for 24 h, the powder was ground with a mortar-and-pestle, sieved to 230 mesh, and calcined at the temperatures specified.

Another method used for synthesizing nickel aluminates comprising metal additives was vapor grafting. This approach may be used for grafting various metals onto supports using the appropriate volatile organometallic complex precursor. In one embodiment, bis(2,2,6,6-tetramethyl-3,5-heptanedionato) (1,5,-cyclo-octadiene) ruthenium(II) ((C₁₁O₁₉O₂)₂(C₈H₁₂)Ru, 99.9%, Strem) was selected as the Ru precursor as it has a sublimation temperature as low as 100° C. at 0.05 torr. Excess Ru precursor and calcined nickel aluminate were loaded at a weight ratio of 1:10 to obtain a final Ru loading of ˜1 wt %. During the vapor grafting process, the apparatus containing Ru precursor and nickel aluminate was kept at <0.1 torr in an oil bath at 145° C. The nickel aluminate vapor-grafted (VG) with Ru was then subjected to calcination.

### Example 2

### Catalyst Characterization

BET surface area of the catalysts was measured by nitrogen adsorption analysis (Micromeritics ASAP 2000). Hydrogen chemisorption was performed on a Micromeritics ASAP 2010 chemisorption system. Typically, 200 mg of calcined samples were first reduced in H₂ at a temperature that was 50° C. lower than the calcination temperature for 2 h. The sample was then cooled to 35° C. and evacuated to 10⁻⁵ mmHg. The chemisorption measurement was performed at equilibrium pressures between 100 and 500 mmHg. Assuming that chemisorption stoichiometry of H:Ni was 1:1, and the surface area occupied by one hydrogen atom was 0.065 nm², the Ni dispersion and metallic surface area was estimated.

The powder X-ray diffraction (XRD) patterns of catalysts after calcination, reduction, reaction and re-oxidation were obtained with a Siemens D5000 θ-θ X-ray diffractometer (45 kV, 40 mA, Cu—K_{α}). The volume-averaged crystallite size was calculated based on Scherrer's analysis of the XRD peak broadening. The morphologies of the catalyst before and after reaction were investigated with high-resolution transmission electron microscopy (HR-TEM) (JEOL 2010) at 200 kV. In addition, energy-dispersive X-ray (EDX) spectroscopy was performed to obtain the elemental mapping of a given area.

Temperature-programmed reduction (TPR) was conducted under a reducing atmosphere using a Perkin Elmer System 7HT Thermal Gravimetric Analyzer (TGA). 20 mg of calcined catalysts were first pretreated under air flow at a temperature that was 50° C. lower than the calcination temperature for 1 h to remove the adsorbed contaminants. After cooling to 50° C. and purging in He for 10 min, a stream of 5% H₂ in He was introduced at a flow rate of 100 mL/min. The temperature was ramped from 30° C. to 900° C. at a rate of 5° C./min to record the weight loss.

### Example 3

### Catalyst Activity and Selectivity

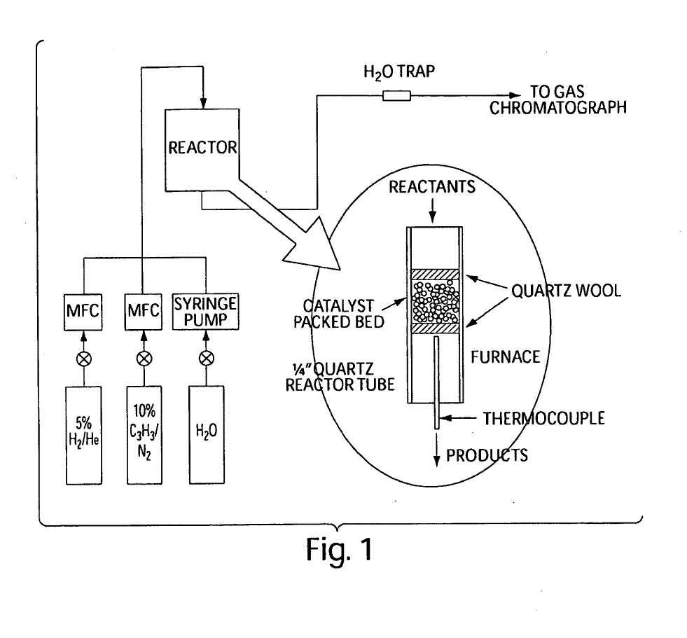

The activity and selectivity of the catalysts were evaluated under steady state in a packed bed reactor (FIG. 1). The catalyst (50 mg) was loaded into a ¼″-O.D. quartz reactor tube, and placed between two quartz wool plugs. To control the reaction temperature accurately, a type-K thermocouple located right below the catalyst bed was used in conjunction with an Omega temperature controller and a Lindberg tube furnace. The gas flow was metered using mass flow controllers (MFC), and water was injected by a syringe pump and vaporized in a pipe wrapped with heating tape. The catalyst was first pretreated at a temperature that was 50° C. lower than the calcination temperature in a stream of 5% H₂ in He at a flow rate of 50 mL/min. The reduction time was varied from 2 to 16 h. Following the reduction process, 10% C₃H₈ in N₂ was introduced with H₂O at a H₂O/C molar ratio of 1-6:1, and the reaction was initiated at a temperature that was 100° C. lower than the calcination temperature. A space velocity of 70,000h⁻¹was used for the reactant gases in these runs. A water trap was placed right after the reactor to condense the unreacted water.

The product stream was analyzed by a Hewlett-Packard 6890 Gas Chromatograph (GC) equipped with molecular sieve 5A and Porapak Q chromatographic columns, which allowed CO, CO₂, CH₄, C₂H₄, C₂H₆, C₃H₆, C₃H₈, H₂ and N₂ to be separated and quantified. N₂ was used as an internal standard to obtain precise quantification of the products. The conversion of propane was calculated by Equation 1,

$${X}_{{C}_{3} {H}_{8}} = \frac{{n}_{{C}_{3} {H}_{8}}^{in} - {n}_{{C}_{3} {H}_{8}}^{out}}{{n}_{{C}_{3} {H}_{8}}^{in}} \times 100.$$

The selectivity for the product with a number of carbon atoms in one molecule (CₐH_{b}O_{z}) was obtained from Equation 2,

$${S}_{{C}_{a} {H}_{b} {O}_{z}} = \frac{a \times {n}_{{C}_{a} {H}_{b} {O}_{z}}^{out}}{3 \times ( {n}_{{C}_{3} {H}_{8}}^{in} - {n}_{{C}_{3} {H}_{8}}^{out} )} \times 100.$$

To obtain a hydrogen yield of less than unity, the calculation was based on the reaction,

C₃H₈+6H₂O→3CO₂+10H₂,

whereby 1 mole of C₃H₈ could produce 10 moles of H₂. Since the H₂ signal from GC analysis was not sufficiently reliable, the yield of hydrogen was obtained from the balance of oxygen and hydrogen, as shown in the Equation 3:

$${Y}_{{H}_{2}} = \frac{\begin{matrix}4 \times ( {n}_{{C}_{3} {H}_{8}}^{in} - {n}_{{C}_{3} {H}_{8}}^{out} ) + \\ {\sum }_{ }^{ } z \times {n}_{{C}_{a} {H}_{b} {O}_{z}}^{out} - \\ {\sum }_{ }^{ } \frac{b}{2} \times {n}_{{C}_{a} {H}_{b} {O}_{z}}^{out}\end{matrix}}{10 \times ( {n}_{{C}_{3} {H}_{8}}^{in} - {n}_{{C}_{3} {H}_{8}}^{out} )} \times 100.$$

Carbon balances of ±2% were achieved in these runs.

### Example 4

### Coking Studies

The amount of coke deposited on the catalyst surface during a steam reforming reaction was investigated by temperature-programmed oxidation (TPO) using a Perkin Elmer System 7HT Thermal Gravimetric Analyzer (TGA). Typically, 20 mg of reacted catalysts were first pretreated in He at 500° C. for 1 h to remove the adsorbed water and residual gases on the sample surface. After cooling down to 30° C. rapidly, TPO was performed by ramping to 800° C. at a rate of 5° C./min in a stream of air (flow rate=100 mL/min). The weight loss associated with coke combustion was recorded.

Coking studies were performed with a Perkin Elmer System 7HT TGA. The catalysts were first reduced at 650° C. for 2 h, and subjected to coking under 10% C₃H₈ in N₂ at 600° C. for 1 h. The coked catalysts were exposed to 5%, 10% and 20% H₂O in N₂ in a packed bed reactor at 100-800° C. (ramp=0.8° C./min). A Hewlett-Packard 6890 GC equipped with molecular sieve 5A and Porapak Q chromatographic columns was used to analyze the product stream. The coke remnants on the catalysts after gasification was evaluated by TGA with temperature-programmed oxidation (TPO) in air at 30-800° C. (ramp=5° C./min).

### Example 5

### Effect of Ni/Al Molar Ratio on Nickel Aluminates

Nickel aluminates of various Ni/Al molar ratios were synthesized and calcined at 700° C. in air. XRD patterns showed that only NiAl₂O₄ phase was detected in the Ni-poor and stoichiometric materials. Both NiAl₂O₄ and NiO phases were found in materials with Ni/Al molar ratios of 0.75:1. NiO phase was dominant in materials with Ni/Al molar ratios of ≧1.00:1. Table 1 shows that the BET surface area of nickel aluminate decreased with increasing Ni loading due to increasing grain size. Compared to pure NiO (24.5 nm and 10.1 m²/g), nickel aluminates possessed a much finer grain size (<9 nm) and a surface area that was an order of magnitude higher. These results may indicate higher thermal stability of nickel aluminates against grain growth and surface area reduction.

TABLE 1
BET surface area and XRD grain size of nickel aluminates
(with the Ni/Al ratios specified) and pure NiO,
after calcination at 700° C. in air.

| | BET Surface | NiAl₂O₄ | NiO |
|---|---|---|---|
| Catalyst | Area (m²/g) | Grain Size (nm) | Grain Size (nm) |
| Ni/Al = 0.25:1 | 202.5 | 6.4 | — |
| Ni/Al = 0.50:1 | 194.2 | 7.0 | — |
| Ni/Al = 0.75:1 | 185.4 | 8.7 | 8.1 |
| Ni/Al = 1.00:1 | 168.8 | — | 8.2 |
| Ni/Al = 1.10:1 | 162.5 | — | 8.5 |
| Ni/Al = 1.25:1 | 159.9 | — | 8.6 |
| Ni/Al = 1.50:1 | 153.5 | — | 8.8 |
| Ni/Al = 1.75:1 | 147.3 | — | 8.8 |
| Ni/Al = 2.00:1 | 145.6 | — | 8.9 |
| NiO | 10.1 | — | 24.5 |

Nickel metal is generally understood to be the active ingredient in steam reforming. Thus, the oxide catalyst should be reduced prior to the reaction. The reducibility of the catalyst and the resulting metal dispersion may affect the application temperature and catalytic activity. TPR profiles showed that the Ni-poor and stoichiometric nickel aluminates exhibit some reducibility, with one peak in H₂ uptake at 790° C. and 740° C., respectively. Two peaks were detected at ˜550° C. and ˜710° C. in Ni-rich systems, and the reduction was initiated below 500° C. The low-temperature reduction could be attributed to the reduction of NiO phase present in the Ni-rich systems. Pure NiO showed one TPR peak at 420° C., and the reduction was initiated at ˜360° C. Without wishing to be bound by theory, the high reducibility of pure NiO may be due to the absence of polarizing effect of aluminum ions on Ni—O bonds. Of the nickel aluminates studied in this example, the sample with Ni/Al=1.10 allowed for reduction at the lowest initiation temperature. This may be attributed to its Ni surface area being relatively high (7.1 m²/g, as determined by chemisorption) compared to the other samples. By contrast, the pure NiO sample had a Ni surface area that was almost an order of magnitude smaller (0.8 m²/g).

### Example 6

### Catalytic Activity and Selectivity for Nickel Aluminates

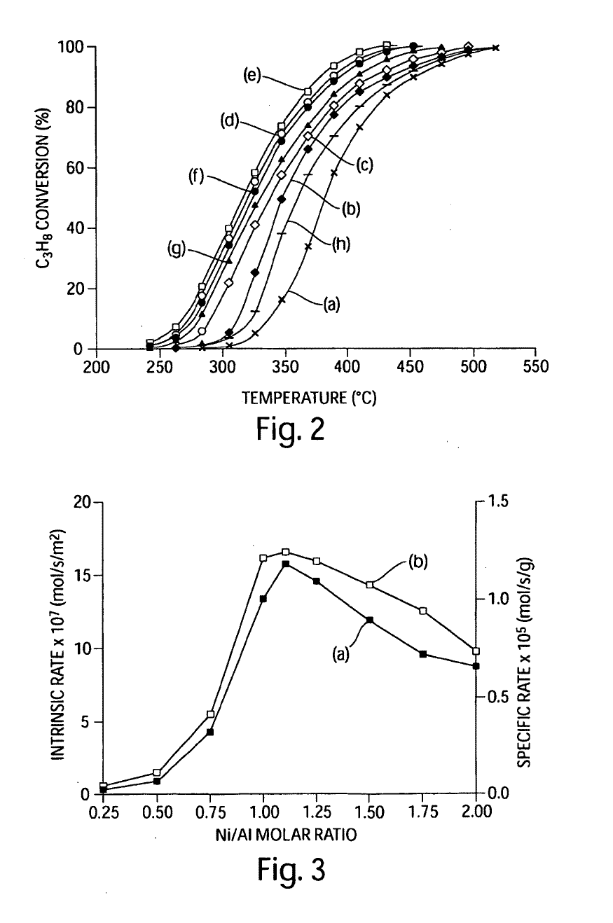

Nickel aluminates were calcined at 700° C. in air, and reduced in 5% H₂ in He for 12 h for complete reduction. The catalysts were then tested for propane steam reforming at a H₂O/C molar ratio of 2:1. The graph in FIG. 2 shows that nickel aluminate with Ni/Al=1.10 provided high catalytic activity, demonstrating the lowest light-off temperature and achieving full propane conversion at 430° C. The existence of an optimal Ni loading in NiO/Al₂O₃ has been reported in the literature, although the value was different for different reactants in steam reforming reactions. For this reaction, the high catalytic activity of the nickel aluminate with Ni/Al=1.10 could be attributed to the high reducibility and active Ni surface area of the catalyst.

Pure NiO was also examined for the steam reforming of propane. However, due to severe coking, which blocked the gas pathway and increased the pressure drop of the catalyst bed, the reaction could not last more than 5 h. Hence, NiO was mixed with Al₂O₃ at a Ni/Al molar ratio of 1.1:0.5. The graph in FIG. 2 shows that this mixture provided very low activity. Although pure NiO possessed higher reducibility compared to nickel aluminates, its low Ni surface area and lower coke resistance led to low catalytic activity.

The specific and intrinsic rates of nickel aluminates at 280° C. are shown by the graph in FIG. 3. The rates were normalized to catalyst weight and Ni surface area, respectively, and showed similar trends with respect to Ni/Al molar ratio. In this case, the highest specific rate was achieved with the nickel aluminate with Ni/Al=1.10:1, which showed the highest propane conversion rate of the ratios included in the graph in FIG. 2. The highest intrinsic reaction rate in this case (16.5×10⁻⁷ mol/s·m²) was also attained by the same catalyst. The intrinsic rate of NiO/Al₂O₃ mixture at 280° C. was only 6.3×10⁻⁷ mol/s·m². This could be due to its greater tendency to deactivate by coking.

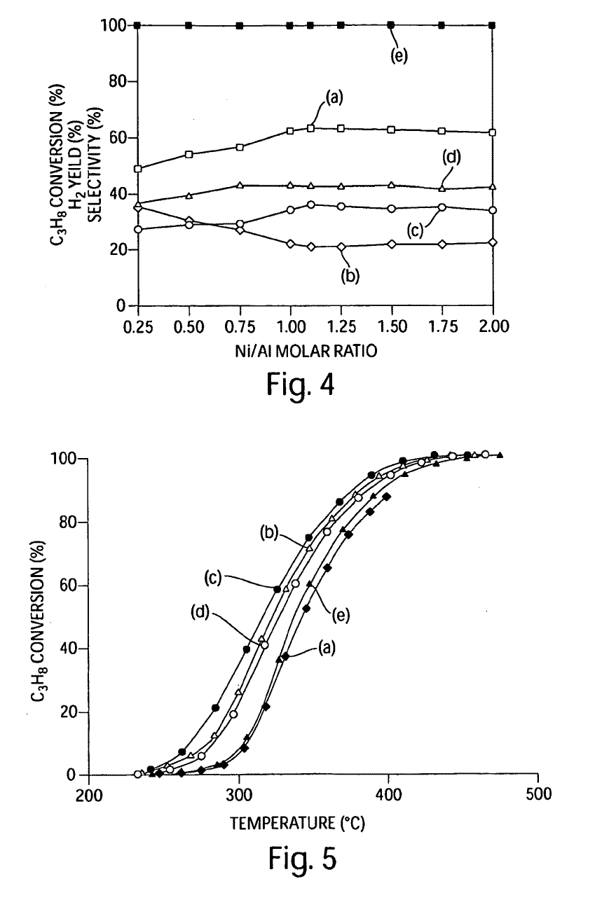

FIG. 4 presents a graph of the average H₂ yield, selectivities for CH₄, CO and CO₂, and C₃H₈ conversion of nickel aluminates at 600° C. for 12 h. C₃H₈ was completely converted over the examined nickel aluminates. The products only consisted of H₂, CH₄, CO and CO₂. The H₂ yield increased with increasing Ni/Al molar ratio up to 1.10:1, and decreased slightly with further increases in Ni/Al molar ratio. The opposite trend was observed in the selectivity for CH₄.

XRD was used to determine the structure of the nickel aluminate with Ni/Al=1.10 after calcination, reduction, reaction, and re-oxidation. Both NiAl₂O₄ and NiO phases were detected in the fresh catalyst. After reduction at 650° C. for 12 h, only metallic Ni was found in the catalyst, which corresponded to the active phase in propane steam reforming. The Ni phase underwent some grain growth from 7.5 nm to 13.6 nm after 12 h of steam reforming reaction (Table 2). Upon re-oxidation in air, both NiAl₂O₄ and NiO phases were detected again in the sample, with some grain growth. ICP-AES confirmed that the Ni/Al ratio remained unchanged after these treatments.

TABLE 2
NiO and Ni grain sizes of nickel aluminate with Ni/Al =
1.10 after calcination, reduction, reaction and re-oxidation.

| Catalyst | NiO Grain Size (nm) | Ni Grain Size (nm) |
|---|---|---|
| Calcined at 700° C. | 8.5 | — |
| Reduced at 650° C. | — | 7.5 |
| Reacted at 600° C. | — | 13.6 |
| Re-oxidized at 800° C. | 14.6 | — |

### Example 7

### Effect of Calcincation Temperature on Nickel Aluminates

The optimal nickel aluminate catalyst for this example (Ni/Al=1.10), the stoichiometric nickel aluminate (Ni/Al=0.50) and the Ni-poor catalyst (Ni/Al=0.25) were calcined at various temperatures between 500° C. and 900° C. The Ni-poor system showed no crystalline peaks at temperatures below 700° C. Using XRD analysis, it was found that NiAl₂O₄ was the only phase detected in this material at 700-900° C. For the stoichiometric nickel aluminate, NiAl₂O₄ phase was detected at 600-900° C. The material was amorphous after calcined at 500° C. The nickel aluminate catalyst with Ni/Al=1.10 possessed both NiO and NiAl₂O₄ phases upon calcination to 500-900° C., but the two phases overlapped in peak positions substantially when calcined at temperatures below 800° C.

This study illustrated that a higher Al content may cause nickel aluminate crystallization to occur at higher calcination temperatures, and provided finer grain sizes to (Table 3). It also prevented the formation of a separate NiO phase, and offered a higher BET surface area. BET surface areas of nickel aluminates were shown to decrease steadily from over 200 m²/g to under 100 m²/g with increasing calcination temperature for a variety of Ni/Al ratios (e.g., 0.25:1, 0.50:1, and 1.10:1) due to increased crystallinity and/or grain growth. The nickel aluminates possessed high BET surface areas of >60 m²/g even after calcination at 900° C., showing higher thermal stability than NiO, which retained a BET surface area of 10 m²/g after calcination at 700° C.

TABLE 3
NiAl₂O₄ and NiO grain sizes of nickel aluminates after
calcination at the temperatures specified.

| | | Calcined | Calcined | Calcined | Calcined |
|---|---|---|---|---|---|
| | | at | at | at | at |
| Catalyst | Phase | 600° C. | 700° C. | 800° C. | 900° C. |
| Ni/Al = 0.25 | NiAl₂O₄ | — | 6.4 | 7.2 | 9.3 |
| Ni/Al = 0.50 | NiAl₂O₄ | 4.7 | 7.0 | 8.0 | 11.1 |
| Ni/Al = 1.10 | NiAl₂O₄ | — | — | 15.8 | 18.4 |
| | NiO | 7.7 | 8.5 | 10.0 | 12.8 |

The optimal nickel aluminate catalyst for this example (Ni/Al=1.10) was calcined at 500-900° C., and studied in H₂ atmosphere. For the sample calcined at 500° C., the reduction was initiated at ˜390° C. The TPR profile was characterized by one broad peak from 390° C. to 750° C. The samples calcined at 600° C., 700° C., 800° C. and 900° C. showed two peaks in the TPR profile, and the two peaks became more discrete with increasing calcination temperature. This could be associated with the increasingly distinct formation of separate NiO and NiAl₂O₄ phases at higher calcination temperatures. The sample calcined at 900° C. has a particularly intense low-temperature peak at ˜600° C. and a small high-temperature peak at ˜850° C. The former could be attributed to the reduction of NiO, which has emerged as a distinct and dominant crystalline phase with a grain size of 12.8 nm. Calcination at higher temperatures led to increased crystallinity and grain growth, thus, the samples would require a higher temperature for reduction to initiate.

Nickel aluminate with Ni/Al=1.10 was calcined at 500-900° C., and was reduced for 2 h at a temperature that was 50° C. lower than the calcination temperature. Of these, the 700° C-calcined sample possessed the highest Ni surface area. Samples calcined and reduced at lower temperatures showed lower Ni surface area possibly due to incomplete reduction. Calcination and reduction at higher temperatures might have led to lower Ni surface area due to grain growth and sintering.

Propane conversions of nickel aluminate samples with Ni/Al=1.10 calcined at temperatures between 500-900° C. were also measured, as illustrated in the plot in FIG. 5. Of these, the 700° C.-calcined sample showed the highest catalytic activity, while the 500° C.-calcined sample displayed the lowest catalytic activity. The catalytic performance illustrated the same trend as the Ni surface area with regard to calcination temperature. This confirmed the direct correlation of propane conversion with Ni dispersion in the nickel aluminate system (Ni/Al=1.10).

The specific and intrinsic reaction rates at 280° C. for nickel aluminate with Ni/Al=1.10 calcined to different temperatures were also measured. Since the specific rate was normalized to catalyst weight, the trend should match those observed for the active surface area and the propane conversion. Of these, the 700° C.-calcined sample displayed the highest specific and intrinsic reaction rates. As expected, the intrinsic reaction rate was not substantially affected by the calcination temperature as it was normalized to the Ni surface area. The exception was the 900° C.-calcined sample with a much lower intrinsic reaction rate (6.5×10⁻⁷ mol/s·m² compared to around 15×10⁻⁷ mol/s·m² for the other samples), which was similar to that of NiO/Al₂O₃ mixture (molar ratio=1.1:0.5) (6.3×10⁻⁷ mol/s·m²). Without wishing to be bound by theory, this suggests that the lower intrinsic reaction rate can be attributed to the weaker interaction between Ni and Al in the 900° C.-calcined sample, which led to significant deactivation due to coking.

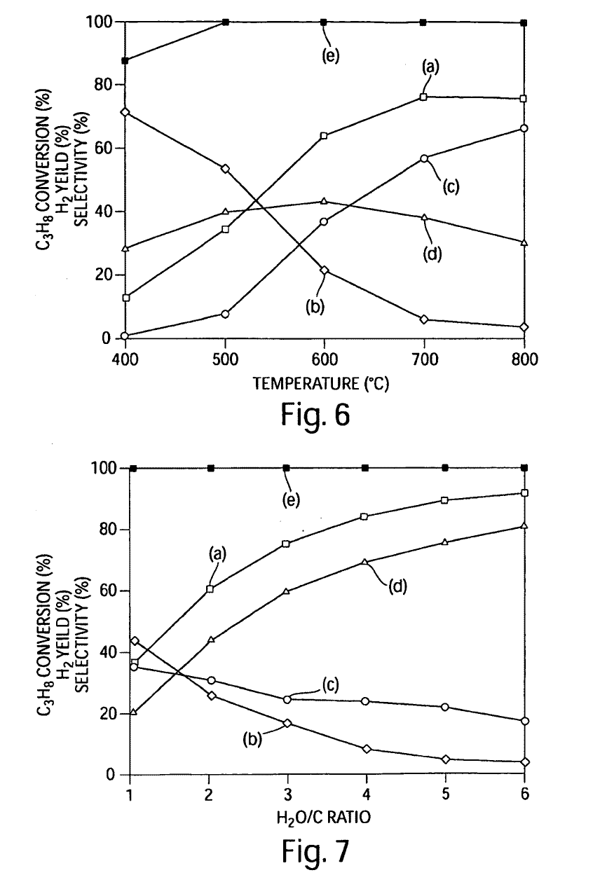

The average values of H₂ yield, selectivities for CH₄, CO and CO₂, and C₃H₈ conversion were obtained at a reaction temperature that was 100° C. below the calcination temperature. The graph in FIG. 6 shows that 88% conversion of propane was achieved at 400° C., while 100% conversion of propane was attained at ≧500° C. The selectivity for CH₄ decreased with increasing reaction temperature due to the enhanced H dissociation at high temperatures. Low reaction temperatures favored CO₂ production and inhibited CO production due to the exothermic water-gas shift reaction. High reaction temperatures enhanced H dissociation and C oxidation to generate more H₂ and CO₂, but these processes were in competition with the water-gas shift reaction. During these tests, the highest H₂ yield was achieved at 700° C., and the highest selectivity for CO₂ was obtained at 600° C.

The steam reforming reaction over nickel aluminate with Ni/Al=1.10 was held for 12 h at various reaction temperatures. Some decrease in propane conversion was noted over time at 400° C., but the selectivities and hydrogen yield remained essentially unchanged over 12 h. The catalytic activity, selectivities and hydrogen yield were stable for 12 h between 500° C. and 800° C. This high stability illustrated the excellent coke resistance of nickel aluminate with Ni/Al=1.10, and may be advantageous in various industrial applications.

Without wishing to be bound by theory, the mechanism of propane steam reforming over nickel aluminates may, in some embodiments, involve the dissociative adsorption of C₃H₈ onto the catalyst, resulting in CHₓ, which may then undergo either H extraction to produce H₂, or CO or carbon deposition on the catalyst surface or H adsorption to produce CH₄. Next, CO may react with H₂O to further produce CO₂. Therefore, more H₂ would be extracted from both C₃H₈ and H₂O with increasing reaction temperature. CO might only begin to appear at temperatures above 400° C. as the exothermic water-gas shift reaction would convert CO to CO₂ at low temperatures. Therefore, CO production may increase with increasing temperature, while CO₂ production may first increase with temperature and then decrease when the temperature is raised beyond 400° C. Below 348° C., increasing CH₄ was produced with increasing temperature due to the dissociative adsorption of C₃H₈. However, CH₄ production decreased above 348° C. as the dissociative adsorption of C₃H₈ progressed further with H extraction. The equilibrium value for CH₄ composition was much higher at low temperatures than that experimentally obtained. This may be due to the fact that the reaction was too slow to achieve the equilibrium values at low temperatures.

XRD analysis was performed on the nickel aluminate with Ni/Al=1.10 after propane steam reforming at different reaction temperatures. Only metallic Ni phase was detected in the samples, illustrating that the reduction of NiO and NiAl₂O₄ phases could be achieved even at relatively low temperatures. This was likely due to the fact that nanocrystals of NiO and NiAl₂O₄ were derived in nickel aluminate synthesis, which facilitated the reduction process. Table 4 shows the grain sizes after calcination, reduction, and reaction. The reduction temperature and reaction temperature were 50° C. and 100° C. below the calcination temperature, respectively. In each case, the Ni grain size after the reduction was not significantly different from the NiO grain size before the reduction. However, the Ni grains underwent significant grain growth during the reaction, especially when the reaction temperature was high.

TABLE 4
NiO and Ni grain sizes of nickel aluminate with Ni/Al =
1.10 after calcination, reduction and reaction.

| Calcination | NiO Grain Size | Ni Grain Size | Ni Grain Size |
|---|---|---|---|
| Temperature | After Calcination | After Reduction | After Reaction |
| (° C.) | (nm) | (nm) | (nm) |
| 500 | 6.3 | 5.2 | 8.3 |
| 600 | 7.7 | 6.2 | 9.4 |
| 700 | 8.5 | 7.5 | 13.6 |
| 800 | 10.0 | 9.7 | 14.0 |
| 900 | 12.8 | 13.8 | 27.4 |

### Example 8

### Effect of Catalyst Pretreatment for Nickel Aluminates

To investigate the effect of catalyst pretreatment on catalytic activity, 700° C.-calcined nickel aluminate with Ni/Al=1.10 was reduced in 5% H₂ in He at 650° C. for 2-16 h. XRD analysis showed that only Ni phase was detected in the samples. This study indicated that 2 h was sufficient for reducing the NiO and NiAl₂O₄ phases at 650° C.

The catalysts pretreated for different time periods were used in the steam reforming of propane. Catalytic activity increased slightly with an increase in reduction time, which could be attributed to the higher Ni surface area. H₂ chemisorption indicated the Ni surface area of samples reduced for 2 h and 12 h to be 7.1 m²/g and 8.0 m²/g, respectively. Since the effect of reduction period on catalytic activity was minor, a short reduction period of 2 h was used in subsequent studies.

The average values of H₂ yield, selectivities for CH₄, CO and CO₂, and C₃H₈ conversion at 600° C. were measured as a function of reduction period (from 2 to 16 hours). Propane was converted completely in these cases. H₂ yield increased from 60% to 64% with increasing reduction period from 2 h to 10 h; only minor increase was observed with longer reduction time. The selectivity for CH₄ decreased slightly with increased reduction period, possibly because slightly more active sites were available for H extraction from CH₄. Selectivities for CO and CO₂ did not vary much with reduction time.

XRD analysis was performed on reacted catalysts that had been reduced at 650° C. for different periods. In these cases, metallic Ni was the only phase present. Table 5 shows that the samples underwent substantial grain growth during the steam reforming reaction. The reduction period only had very minor effects on the grain size of the samples.

TABLE 5
Ni grain size of nickel aluminate with Ni/Al = 1.10 after reduction
at 650° C. and after reaction at 600° C.

| Reduction | Ni Grain Size (nm) | Ni Grain Size (nm) |
|---|---|---|
| Period (h) | After Reduction | After Reaction |
| 2 | 7.3 | 12.7 |
| 6 | 7.4 | 13.1 |
| 10 | 7.5 | 13.5 |
| 12 | 7.5 | 13.6 |
| 16 | 7.8 | 14.1 |

### Example 9

### Effect of H₂O/C Ratio on Nickel Aluminates

The graph in FIG. 7 shows the effect of H₂O/C ratio on propane steam reforming over 700° C.-calcined nickel aluminate with Ni/Al=1.10:1. Complete conversion of propane was achieved even at a low H₂O/C ratio of 1:1. The introduction of more water enhanced the C oxidation, and decreased the selectivity for CH₄. Increasing H₂O/C ratio led to increased and decreased selectivities for CO₂ and CO, respectively, as driven by the water-gas shift reaction. H₂ yield increased with increasing H₂O/C ratio as more H could be extracted from C₃H₈ and H₂O.

XRD analysis showed that the catalysts reacted at various H₂O/C ratios showed a metallic Ni phase. Table 6 shows that propane steam reforming led to grain growth, the extent of which depended on H₂O/C ratios. Larger grain size was obtained at a high H₂O/C ratio, as water vapor facilitated sintering and grain growth.

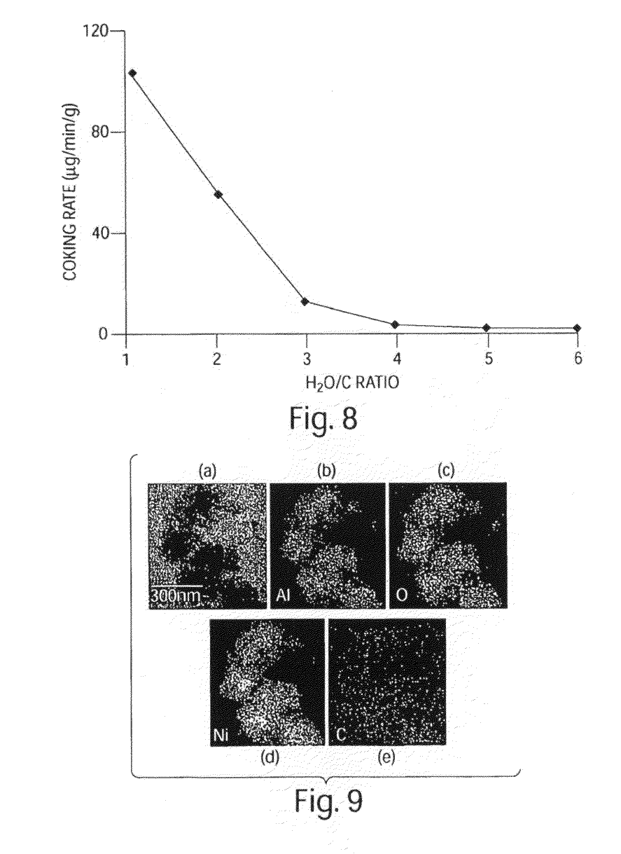

The coke formation rate during propane steam reforming at 600° C. was examined. When a higher H₂O/C ratio was employed, much less coke was deposited on the catalyst (FIG. 8). This may be because water introduction improved the oxygen transfer to the adsorbed carbon species on the catalyst surface, enhancing the oxidation of carbon atoms.

Severe coke formation on nickel surface has been the major challenge for nickel-based catalysts. The mechanism of coke formation has been previously investigated, and it is generally understood in the art that coke formation on nickel surface is due mainly to the dissociation of hydrocarbons to produce highly reactive monatomic carbon C_{α}, which may be easily combined with adsorbed oxygen or hydroxyl group to produce carbon monoxide. However, excess C_{α} could lead to polymerization to form C_{β}, which is much less active and may accumulate on the nickel surface or may diffuse into the crystal structure. Three types of coke have been reported in the steam reforming of hydrocarbons over supported catalysts:

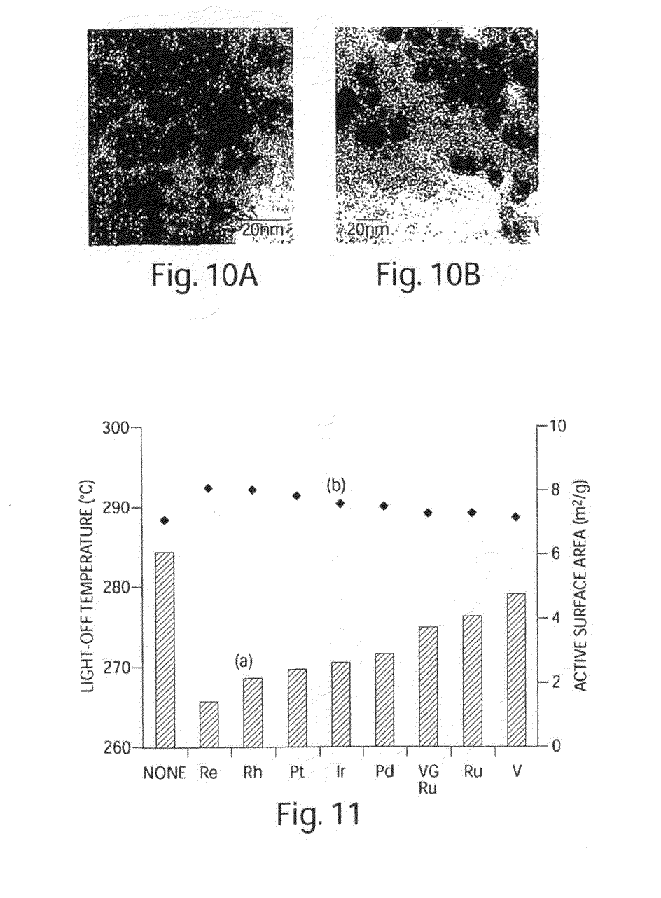

pyrolytic, encapsulating and whisker coke. Pyrolytic coke may be generated by the decomposition of hydrocarbons in the gas phase, while encapsulating and whisker coke may be formed on metallic sites. Typically, whisker carbon can be detected in nickel-based catalysts, and may be initiated from nickel carbide formation. Carbonaceous species may be dissolved and may diffuse through the nickel particle to the grain boundary, precipitating at the end of the nickel particle. This process may continue over time, forming a carbon filament at the edge of the nickel particle. In some illustrative examples described herein, whisker carbon was deposited on the nickel aluminate catalysts during propane steam reforming, as shown in FIG. 10. The elemental maps, such as those in FIG. 9, showed that a high dispersion of Ni on the aluminate support was retained during the reaction. The non-homogeneous dispersion of carbon was associated with coke deposition on the catalyst surface during steam reforming. The micrographs in FIG. 10 also show the increase in catalyst grain size after reaction.

TABLE 6
Ni grain size of nickel aluminate with Ni/Al = 1.10 after reduction
at 650° C. and after reaction at 600° C. at the H₂O/C ratio specified.

| H₂O/C | Ni Grain Size (nm) | Ni Grain Size (nm) |
|---|---|---|
| Ratio | After Reduction | After Reaction |
| 1:1 | 7.3 | 11.6 |
| 2:1 | 7.3 | 12.7 |
| 3:1 | 7.3 | 14.1 |
| 4:1 | 7.3 | 15.2 |
| 5:1 | 7.3 | 15.9 |
| 6:1 | 7.3 | 16.1 |

### Example 10

### Metal Additives in Modified Nickel Aluminates

Various metals were introduced at ˜1 wt % loading onto nickel aluminate with Ni/Al ratio of 1.10:1 by wet impregnation or vapor grafting, and calcined at 700° C. The first group of metal additives, Re, Rh, Pt, Ir, Pd, Ru and V, gave rise to improved reducibility, allowing the modified catalysts to be reduced at a temperature of ˜50° C. lower than the unmodified nickel aluminate with Ni/Al=1.10. TPR analysis revealed that their low-temperature peak was more intense, and shifted to a lower temperature.

A second group of metal additives, Fe, La, Co, Mn, Os, Sr and Ce, showed less impact on the reducibility of nickel aluminate. The modified catalysts were reduced at a temperature of ˜20° C. lower than the unmodified nickel aluminate. TPR analysis revealed that their low-temperature peak was similar to that of the unmodified catalyst. The third group of promoters, Ta, Mo, Cr, Au, Sm, Nb, Cu, W, Sn and Ag, showed either negligible or negative impact on the catalyst reducibility.

The graph in FIG. 11 compares the steam reforming light-off temperatures (corresponding to 10% propane conversion) over nickel aluminate (with Ni/Al=1.10) with the first group of promoters. The decreased light-off temperature was consistent with the increased active surface area due to the improved reducibility associated with this group of additives. Compared to the unmodified catalyst, Re-promoted catalyst lowered the light-off temperature by 20° C. The catalysts with the first group of promoters also offered higher H₂ yield and lower CH₄ selectivity compared to unmodified nickel aluminate, as the higher active surface area facilitated carbon oxidation to generate more H₂.

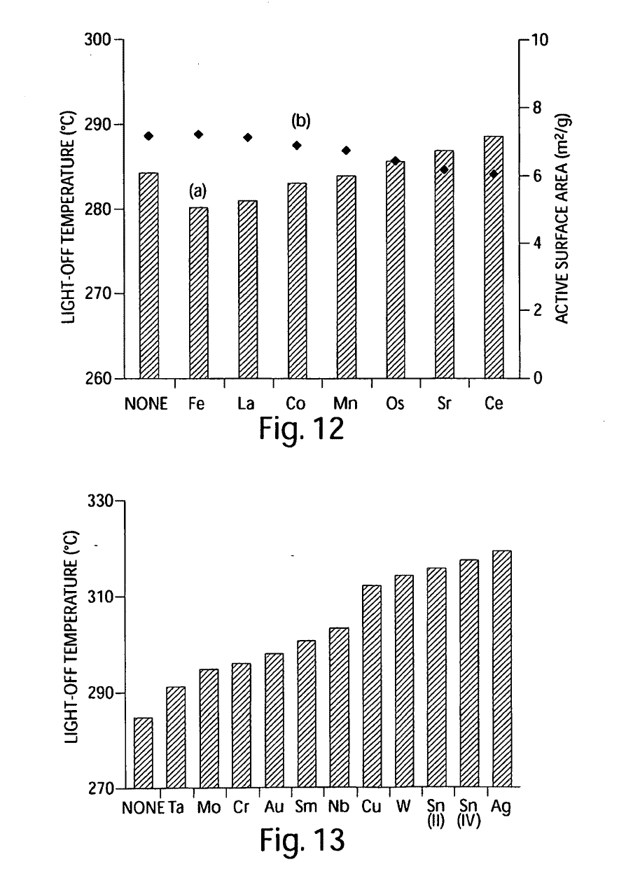

As shown in the graph in FIG. 12, the second group of promoters showed minor effect on the active surface area and catalytic activity in propane steam reforming. The graph in FIG. 13 shows that the third group of promoters led to lower catalytic activity compared to the unmodified nickel aluminate.

### Example 11

### Effect of Metal Additives on Catalytic Activity of Modified Nickel Aluminates

The first group of metal additives gave rise to some improvement in catalytic activity. This benefit was less significant in the 700° C.-calcined catalysts. To examine the modified catalysts in more detail, the modified catalysts were calcined at 600° C. and tested for propane steam reforming. XRD analysis showed that the Ru-modified catalyst formed a detectable separate phase, RuO₂, especially when the Ru was vapor-grafted. Other modified catalysts showed similar XRD peaks as the nickel aluminate with Ni/Al=1.10, due to the high dispersion of their metal additives. Table 7 illustrates that the grain size of NiO was not significantly affected by the impregnation or vapor grafting of promoters, and the subsequent calcination process.

TABLE 7
NiO grain size of nickel aluminate with Ni/Al = 1.10 and 1 wt %
of the promoter specified, after calcination at 600° C.

| Promoter | NiO Grain Size (nm) |
|---|---|
| — | 7.7 |
| Re | 7.8 |
| Rh | 8.5 |
| Pt | 8.9 |
| Ir | 8.8 |
| Pd | 9.2 |
| VG Ru | 8.6 |
| Ru | 10.1 |
| V | 8.9 |

TPR profiles indicated that the reducibility was improved significantly by the introduction of promoters, including Re. The modified catalysts were reduced at a temperature of 50-100° C. lower than the unmodified nickel aluminate with Ni/Al=1.10. Their low-temperature peak was substantially more intense, and shifted to a lower temperature. Compared to the 700° C.-calcined catalysts, the 600° C.-calcined catalysts showed greater reducibility.

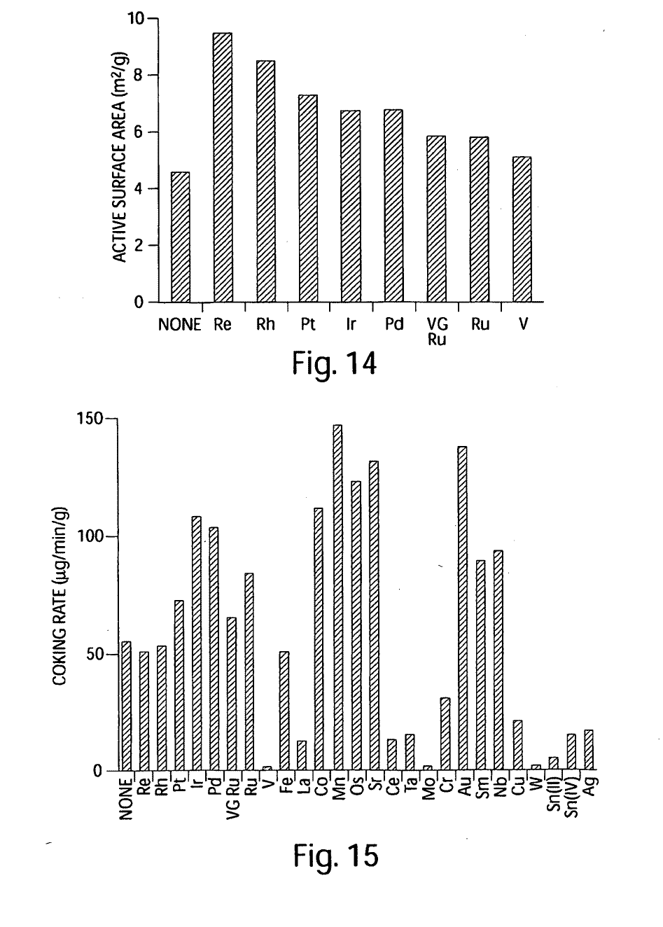

The graph in FIG. 14 shows that the promoters resulted in modified catalysts with a substantially higher active surface area, especially in the case of Re. For the Re-modified catalyst, the 600° C.-calcined sample showed a higher active surface area than the 700° C.-calcined sample, as shown in the graph in FIG. 11.

Due to the increased active surface area, both the catalytic activity and H₂ yield were enhanced significantly by introducing the promoters, in the order of Re>Rh>Pt>Ir>Pd>vapor-grafted Ru>Ru>V. In particular, the light-off temperature was decreased by over 50° C. and the H₂ yield was increased by 6.4% with the addition of Re.

To investigate the effect of promoter loading, 2 wt % of metal additives were introduced to nickel aluminate with Ni/Al=1.10. 1 wt % Re-promoted catalyst gave higher propane conversion and H₂ yield, compared to the various catalysts with 2 wt % promoters.

To further improve the catalytic activity, 1 wt % of a second promoter was introduced to 1 wt % Re-promoted nickel aluminate. The results showed that Re,Ru-promoted system provided the highest catalytic activity of the systems examined. The Re,Ru-modified nickel aluminate (Ni/Al=1.10) was then further optimized, and the results showed that 2 wt % Re,2 wt % Ru-promoted system had the highest catalytic activity of the systems examined. Therefore, 2 wt % of various second promoters were introduced to 2 wt % Re-modified nickel aluminate (Ni/Al=1.10). Of the various metals examined as the second promoter (e.g., Ru, Ir, V, Rh, Pd, and Pt), Ru exhibited the highest catalytic activity. However, the 2 wt % Re,2 wt % Ru-promoted nickel aluminate exhibited lower catalytic activity and H₂ yield when compared to the 1 wt % Re-promoted nickel aluminate.

### Example 12

### Screening Metal Additives for Coke Resistance in Modified Nickel Aluminates

The graph in FIG. 15 shows the coking rate during propane steam reforming at 600° C. over modified nickel aluminates. Re and Rh additives had small effect on coking rate, while Pt, Ir, Pd and Ru additives led to more severe coking. Coke formation was significantly inhibited with the addition of V, Mo, and W. However, Mo and W also exhibited a negative impact on the catalytic activity of nickel aluminate. V successfully promoted coke resistance and catalytic activity simultaneously. Thus, V was added as a second metal to suppress coke formation in Re-modified nickel aluminate.

### Example 13

### Effect of Re Loading on Re-Promoted Catalysts

Various loadings of Re were introduced to nickel aluminate with Ni/Al=1.10, and calcined at 600° C. to investigate the effect of Re loading. XRD analysis indicated that nickel aluminate was not significantly altered by Re loadings of ≦5 wt %. No separate Re-related phases were formed after the Re impregnation and subsequent calcination processes, illustrating the uniform dispersion of Re on the nickel aluminate support.

TPR profiles showed that the reducibility of 600° C.-calcined nickel aluminate (Ni/Al=1.10) was improved significantly by Re introduction. However, the TPR profile was quite similar for nickel aluminates with Re loadings of 1-5 wt %. Re-promoted catalysts provided higher active surface areas than unmodified nickel aluminate. Of the samples studied, the highest active surface area was achieved at 1 wt % Re loading. Further increase in Re loading actually led to decreasing active surface area, suggesting that agglomeration might have led to reduced metal dispersion.

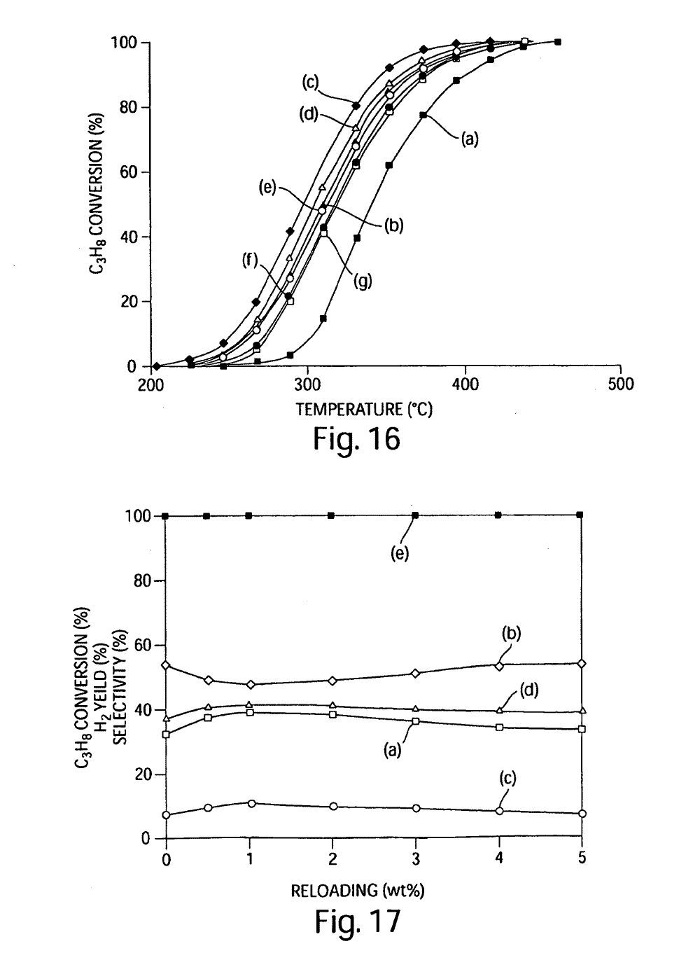

The graph in FIG. 16 shows that 1 wt % Re-promoted catalyst provided the highest catalytic activity of the samples studied, with complete propane conversion at ˜410° C. The graph in FIG. 17 shows that, of the samples studied, the highest H₂ yield at 500° C. was also achieved by 1 wt % Re-promoted nickel aluminate. The trends of both catalytic activity and H₂ yield matched that of the active surface area.

XRD analysis was performed on 1 wt % Re-promoted nickel aluminate that had been reduced, reacted, and oxidized. Overlapping NiAl₂O₄ and NiO peaks were observed after calcination at 600° C. However, these peaks were replaced by Ni peaks after reduction at 550° C. The Ni peaks were retained after the steam reforming reaction with minor increase in grain size (Table 8). The Ni phase disappeared upon re-oxidation at 800° C., which brought back NiAl₂O₄ and NiO phases with minor grain growth.

TABLE 8
NiO and Ni grain sizes of 1 wt % Re-promoted nickel aluminate (Ni/Al =
1.10) after calcination, reduction, reaction and re-oxidation.

| Catalyst | NiO Grain Size (nm) | Ni Grain Size (nm) |
|---|---|---|
| Calcined at 600° C. | 7.8 | — |
| Reduced at 550° C. | — | 6.9 |
| Reacted at 500° C. | — | 8.8 |
| Re-oxidized at 800° C. | 9.2 | — |

### Example 14

### Effect of Calcination Temperature on Re-Promoted Catalysts

In order to investigate the effect of calcination temperature, 1 wt % Re-promoted nickel aluminate (Ni/Al=1.10) was calcined at 500-700° C. Similar XRD patterns with overlapping NiAl₂O₄ and NiO peaks were obtained for the catalysts calcined at different temperatures, while the grain size increased from 7.0 nm to 9.5 nm with increasing calcination temperature from 500° C. to 700° C. (Table 9).

TABLE 9
NiO grain sizes of 1 wt % Re-promoted nickel aluminate (Ni/Al =
1.10) after calcination at various temperatures.

| Calcination | |
|---|---|
| Temperature | |
| (° C.) | NiO Grain Size (nm) |
| 500 | 7.0 |
| 600 | 7.8 |
| 700 | 9.5 |

TPR profiles showed that both unmodified and 1 wt % Re-promoted nickel aluminates exhibited improved reducibility when calcined at a lower temperature. Greater reducibility was achieved with Re promoter at a given calcination temperature. This could be attributed to the increase in active surface area with 1 wt % Re addition. The highest active surface area of the studied samples was achieved with the Re-promoted catalyst calcined at 600° C. The effect of Re addition on active surface area was particularly significant for samples calcined at 500° C. The presence of Re has promoted reducibility and metal dispersion, so that high temperatures were not necessary to attain those desired characteristics.

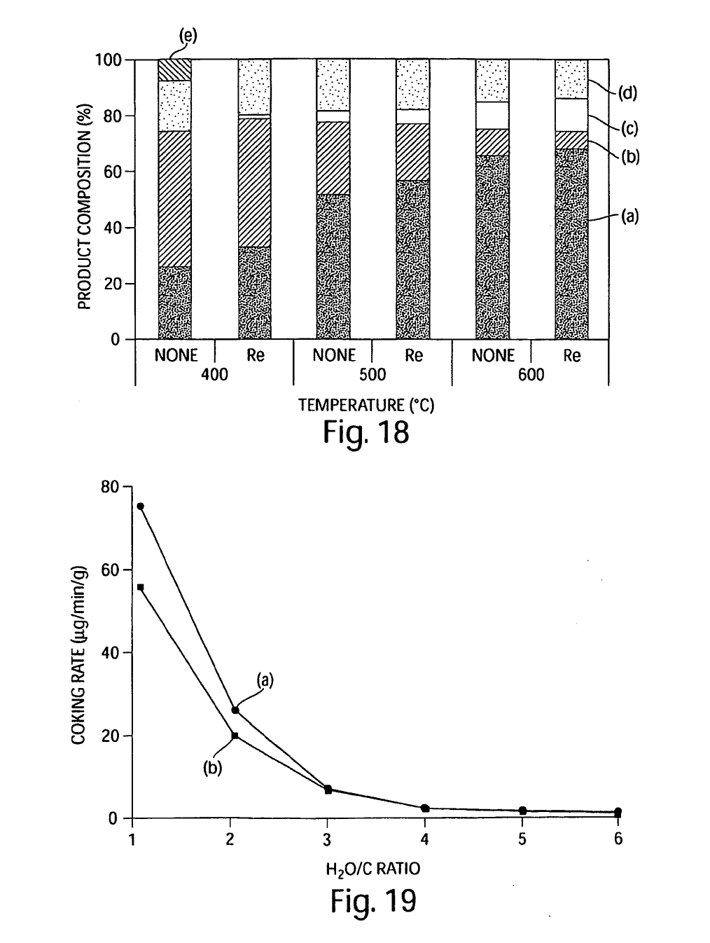

Following calcination, the nickel aluminate catalysts with and without 1 wt % of Re were reduced at a temperature that was 50° C. lower than the calcination temperature. Re-promoted catalyst showed improved performance compared to the unmodified nickel aluminate. The trend in catalytic activity matched that of the active surface area. Of the samples studied, the Re-promoted nickel aluminate calcined at 600° C. gave rise to the highest catalytic activity as it possessed the highest active surface area. The graph in FIG. 18 shows the effect of Re on the product compositions at various reaction temperatures. Re addition improved the production of H₂, especially at lower temperatures.

The stability of 1 wt % Re-promoted nickel aluminate in propane steam reforming was examined between 400° C. and 600° C. The catalytic performance of this system was consistent over a period of 12 h.

### Example 15

### Effect of Space Velocity on Re-Promoted Catalysts

The effect of space velocity on the catalytic activity of unmodified and Re-promoted nickel aluminate in propane steam reforming was also investigated. For both systems, the catalytic activity decreased with increasing space velocity due to shorter contact time. At each space velocity, the Re-promoted catalysts provided a higher catalytic activity than the unmodified catalysts. The H₂ yield, selectivity for CH₄, and C₃H₈ conversion were also measured as a function of space velocity. The selectivities for CO and CO₂ were similar at different space velocities. A higher H₂ yield was achieved with Re addition and at a lower space velocity, which corresponded to a lower selectivity for CH₄.

### Example 16

### Effect of H₂O/C Ratio on Re-Promoted Catalysts

1 wt % Re-promoted nickel aluminate was examined for propane steam reforming under H₂O/C ratios of 1-6:1 at temperatures of 400° C., 500° C., and 600° C. At these three temperatures, H₂ yield increased with an increase in H₂O/C ratio. The coking rate was also measured for experiments in which no promoter and 1% Re were used, the results of which are shown in the graph in FIG. 19. The coking rate of Re-promoted catalyst was lower than the unmodified nickel aluminate at H₂O/C ratio=1:1. The coking rate decreased significantly with increasing H₂O/C ratio. While a high H₂O/C ratio helped to inhibit coke formation, the energy cost associated with the introduction of large quantities of H₂O may be high.

### Example 17

### V-Promoted Catalysts

Re, V-promoted nickel aluminates were examined to provide high catalytic activity and coke resistance at a low H₂O/C ratio of 1:1. Before optimizing the Re, V-promoted nickel aluminate system, V-promoted nickel aluminates (Ni/Al=1.10:1) were studied to determine the practical range for V loading. Catalytic activity was not substantially affected by V loadings of 1-5 wt %. The V-promoted nickel aluminates outperformed the unmodified catalyst in propane conversion and H₂ yield, especially for the sample containing 3 wt % V. TPR studies showed that the catalyst reducibility improved with increasing V loading.

XRD analysis was conducted for 3 wt % V-promoted nickel aluminate after calcination, reduction, reaction and re-oxidation. Both NiAl₂O₄ and NiO phases formed during calcination at 700° C. were replaced by the Ni phase after reduction. Minor grain growth was observed after reaction at 600° C. Upon re-oxidation in air at 800° C., both NiAl₂O₄ and NiO phases re-emerged with a slightly larger grain size. Table 10 confirmed that the presence of V suppressed the grain growth of the nickel aluminate support and the active nickel nanocrystals during the reduction/reaction/re-oxidation processes.

TABLE 10
NiO and Ni grain sizes of 3 wt % V-promoted nickel aluminate (Ni/Al =
1.10) after calcination, reduction, reaction and re-oxidation.

| Catalyst | NiO Grain Size (nm) | Ni Grain Size (nm) |
|---|---|---|
| Calcined at 700° C. | 11.2 | — |
| Reduced at 650° C. | — | 10.8 |
| Reacted at 600° C. | — | 11.8 |
| Re-oxidized at 800° C. | 11.9 | — |

### Example 18

### Effect of Calcination Temperature for V-Promoted Catalysts

The 3 wt % V-promoted catalyst was calcined at 600-800° C., and compared to the unmodified nickel aluminate for catalytic activity. Higher catalytic activities were achieved over the V-promoted catalyst. The benefit of the V promoter in improving H₂ yield was significant at lower reaction temperatures. The unmodified and V-promoted catalysts provided similarly high H₂ yield at a high reaction temperature of 700° C.

Propane steam reforming was conducted over 3 wt % V-promoted nickel aluminate between 500° C. and 700° C. with a H₂O/C ratio of 1:1. Excellent catalytic activity and selectivities were stably maintained over 12 h. The V-promoted system was able to achieve and maintain equilibrium H₂ yield at the low H₂O/C ratio of 1:1, which confirmed the high coke resistance of the V-promoted nickel aluminate.

### Example 19

### Effect of Space Velocity for V-Promoted Catalysts

Even at a high space velocity of 120,000 h⁻¹ complete propane conversion could be achieved at 485° C. over the highly active, 3 wt % V-promoted nickel aluminate. Higher space velocity led to slightly lower propane conversion and H₂ yield at 600° C.

### Example 20

### Effect of H₂O/C Ratio for V-Promoted Catalysts

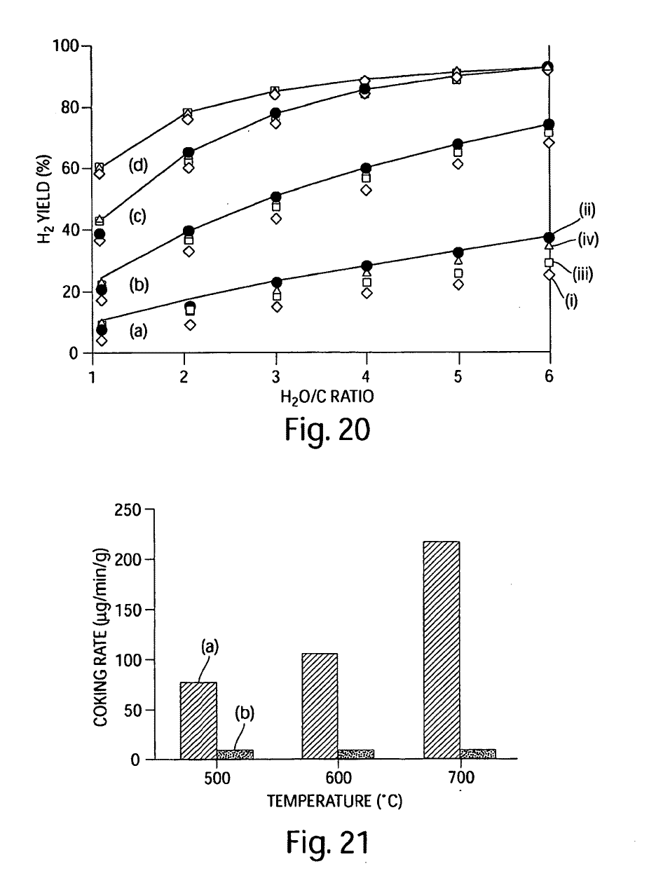

3 wt % V-promoted and unmodified nickel aluminate catalysts were examined for propane steam reforming at H₂O/C ratios of 1-6:1 and various temperatures. The H₂ yield obtained experimentally was compared to the equilibrium calculations, as shown in the plot in FIG. 20. At temperatures higher than 600° C., the experimental results matched the equilibrium calculations. Compared to unmodified nickel aluminate, the catalyst with V promoter provided higher H₂ yield under these conditions, especially at a low H₂O/C ratio of 1:1. Additionally, the catalyst with V promoter greatly improved coking resistance, as shown by the graph in FIG. 21.

### Example 21

### Re, V-Promoted Catalysts

To optimize the Re, V-promoted nickel aluminate system, various loadings of Re and V were introduced onto nickel aluminate (Ni/Al=1.10). The introduction of Re and V promoters helped to reduce the light-off temperature of nickel aluminate in propane steam reforming. The addition of the second promoter, V, further decreased the light-off temperature of Re-promoted nickel aluminate. Nickel aluminate with 2 wt % Re, 2 wt % V provided the lowest light-off temperature. Compared to unmodified and 1 wt % Re-promoted nickel aluminate, 3 wt % V-promoted nickel aluminate and 2 wt % Re,2 wt % V-promoted nickel aluminate provided higher H₂ yield, suggesting that V may improve carbon gasification, facilitating the generation of H₂.

TPR profiles showed that reducibility was initiated at a much lower temperature of 390° C. for 1 wt % Re-promoted, 3 wt % V-promoted, and 2 wt % Re,2 wt % V-promoted nickel aluminates, compared to the unmodified catalyst (460° C.). The TPR profile of 2 wt % Re,2 wt % V-promoted nickel aluminate was similar to that of 1 wt % Re-promoted nickel aluminate, illustrating a significantly enhanced low-temperature TPR peak centered at 460° C. These two catalysts also showed comparable active surface area of 7.8 m²/g and 8.1 m²/g, respectively. This suggested that the excellent reducibility and metal dispersion of Re, V-promoted nickel aluminate may be influenced by the presence of the Re promoter. This study also illustrated that the second promoter, V, did not negatively impact the reducibility and metal dispersion of Re-promoted nickel aluminate, but was able to enhance coke resistance. Without wishing to be bound by theory, the presence of V may inhibit the blockage of active sites by carbon deposition. Consequently, the V addition further increased the catalytic activity of Re-promoted nickel aluminate, especially at a low H₂O/C ratio.

XRD analyses of 2 wt % Re,2 wt % V-promoted nickel aluminate after calcination, reduction, reaction and re-oxidation were also performed. Both NiAl₂O₄ and NiO phases were detected after sample calcination at 700° C. These phases were replaced by the Ni phase after sample reduction. The Ni phase was retained with some grain growth to 9.9 nm after the steam reforming reaction. Upon re-oxidation in air at 800° C., both NiAl₂O₄ and NiO phases re-emerged with minor grain growth (NiO grain size=10.9 nm). The unmodified nickel aluminate underwent substantial grain growth after reaction (Ni grain size=13.6 nm) and re-oxidation (NiO grain size=14.6 nm) (Table 2). Thus, the presence of Re and V suppressed the grain growth of the nickel aluminate support and the active nickel nanocrystals.

TABLE 11
NiO and Ni grain sizes of 2 wt % Re, 2 wt % V-promoted
nickel aluminate (Ni/Al = 1.10) after calcination,
reduction, reaction and re-oxidation.

| Catalyst | NiO Grain Size (nm) | Ni Grain Size (nm) |
|---|---|---|
| Calcined at 700° C. | 9.2 | — |
| Reduced at 650° C. | — | 8.3 |
| Reacted at 600° C. | — | 9.9 |
| Re-oxidized at 800° C. | 10.9 | — |

### Example 22

### Effect of Calcination Temperature for Re, V-Promoted Catalysts

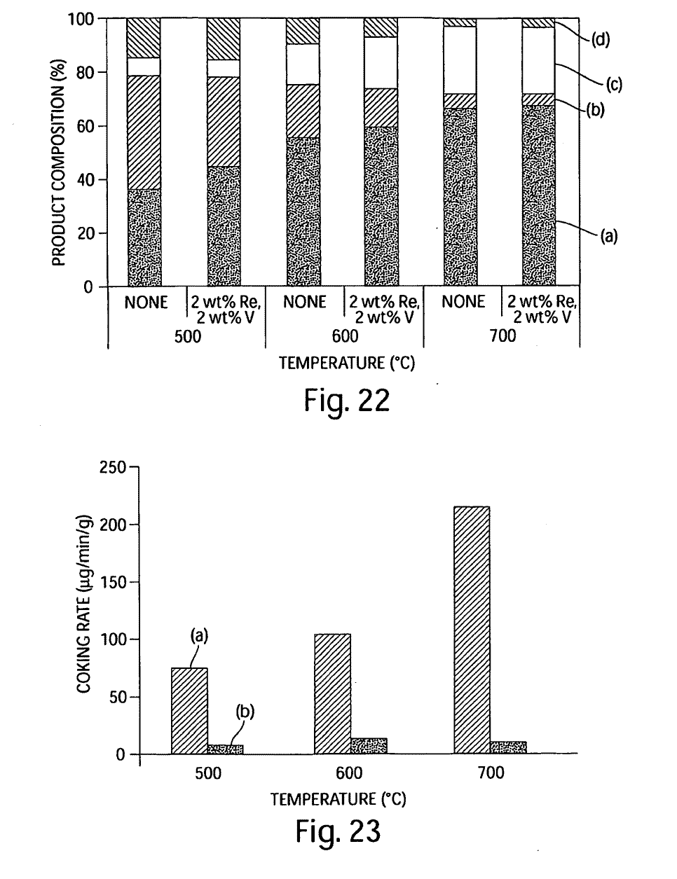

The Re, V-promoted catalyst was calcined at 600-800° C. and compared to unmodified nickel aluminate for catalytic activity. Higher catalytic activities were achieved for the catalyst with Re and V promoters compared to the catalyst with no promoter. Calcination temperature did not have a significant effect on the catalytic activity. Unmodified and Re, V-promoted catalysts provided similarly high H₂ yield at a high reaction temperatures of 700° C. The benefit of the Re and V promoters in improving H₂ yield was more pronounced at 600° C. and even more pronounced at 500° C., as shown in FIG. 22.

Propane steam reforming was conducted over 2 wt % Re,2 wt % V-promoted nickel aluminate between 400° C. and 700° C. with H₂O/C=1. Excellent catalytic activity and selectivities of this system were stably achieved for over 12 h. This Re, V-promoted system was able to achieve and maintain the equilibrium H₂ yield at a low H₂O/C=1, unlike the 1 wt % Re-promoted nickel aluminate. This may illustrate the higher catalytic performance and coke resistance of the Re, V-promoted nickel aluminate.

### Example 23

### Effect of Space Velocity for Re, V-Promoted Catalysts

Even at a high space velocity of 120,000 h⁻¹, complete propane conversion could be achieved at 480° C. over the highly active, 2 wt % Re,2 wt % V-promoted nickel aluminate. Higher space velocity led to slightly lower propane conversion and H₂ yield at 600° C.

### Example 24

### Effect of H₂O/C Ratio for Re, V-Promoted Catalysts

H₂ yield was examined as a function of H₂O/C for unmodified nickel aluminate, 1 wt % Re-promoted nickel aluminate, 3 wt % V-promoted nickel aluminate, and 2 wt % Re,2 wt % V-promoted nickel aluminate, as shown in the plot in FIG. 20. In all cases, the catalysts with promoter(s) provided higher H₂ yields than unmodified catalyst, especially at low temperatures. Of the catalysts studied, the Re-promoted catalyst showed the best results at a low temperature of 400° C. and H₂O/C ratios of ≧2:1. At temperatures of ≧500° C. and H₂O/C ratios of ≧2:1, similar H₂ yields were achieved by the Re-promoted and Re, V-promoted catalysts. At a low H₂O/C ratio of 1:1, the V-promoted and Re, V-promoted catalyst attained the highest H₂ yield of the samples that were studied at all temperatures examined. This system successfully acquired the equilibrium H₂ yield at ≧600° C., illustrating its effectiveness at suppressing coke formation and its thermal/hydrothermal stability over a broad range of H₂O/C ratios (1-6:1).

XRD analyses of 2 wt % Re,2 wt % V-promoted nickel aluminate after propane steam reforming at H₂O/C ratios of 1-6:1 were also conducted. Nanocrystalline Ni was retained under all reaction conditions, indicating the hydrothermal stability of this catalyst. Compared to the results associated with unmodified nickel aluminate (Table 6), the relatively small increase in Ni grain size demonstrated that the presence of Re and V inhibited the grain growth of the active nickel nanocrystals (Table 12).

TABLE 12
Ni grain sizes of 2 wt % Re, 2 wt % V-promoted nickel
aluminate (Ni/Al = 1.10) after reduction at 650° C.
and reaction at 600° C. at the H₂O/C ratio specified.

| H₂O/C | Ni Grain Size (nm) | Ni Grain Size (nm) |
|---|---|---|
| Ratio | After Reduction | After Reaction |
| 1:1 | 8.3 | 9.9 |
| 2:1 | 8.3 | 10.3 |
| 3:1 | 8.3 | 10.9 |
| 4:1 | 8.3 | 11.4 |
| 5:1 | 8.3 | 11.9 |
| 6:1 | 8.3 | 12.2 |

### Example 25

### Coking Studies for Re, V-Promoted Catalysts

The coke formation rates over unmodified and 2 wt % Re,2 wt % V-promoted nickel aluminates were compared at a low H₂O/C ratio of 1:1, and the results are shown in the graph in FIG. 23. Re, V-promoted catalyst showed high coke resistance at 500-700° C., dramatically reducing the coke formation rate. Coking became more severe with increasing reaction temperature over unmodified nickel aluminate, but was insignificant at all temperatures over the Re, V-promoted catalyst.

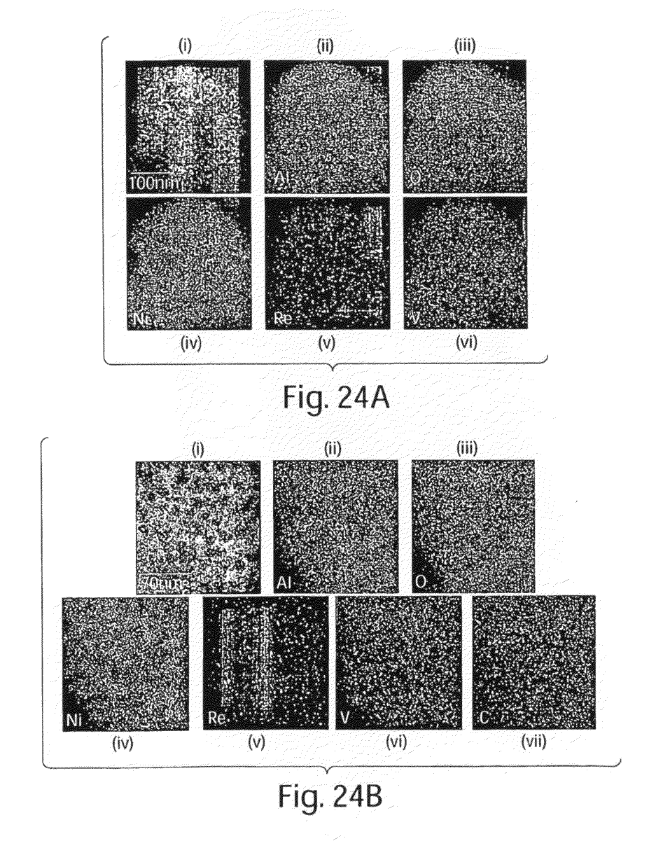

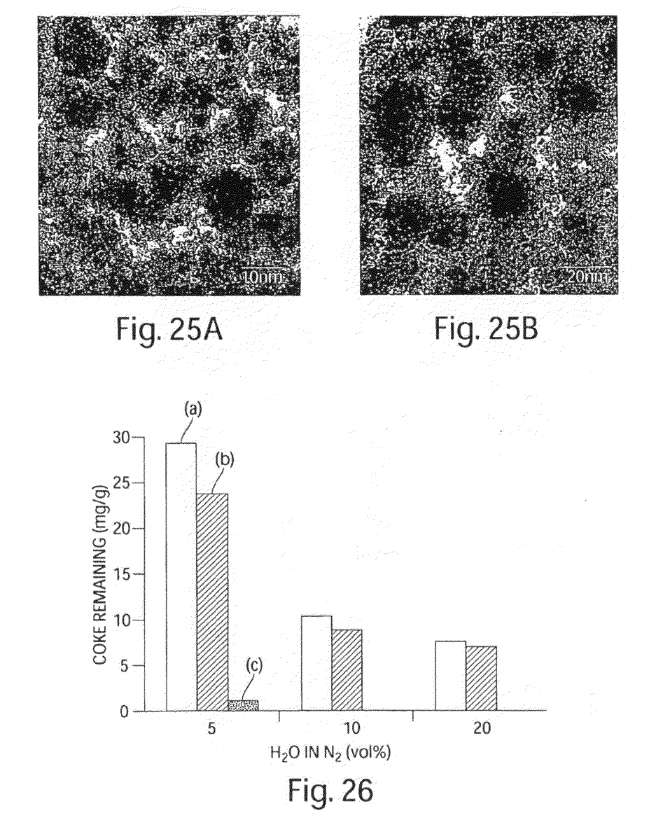

The elemental maps of Re, V-promoted nickel aluminate (Ni/Al=1.10) after reduction and reaction are shown in FIG. 24. Ni, Re and V were highly dispersed over the oxide support after the reduction. Distinct nanocrystals of Ni were observed after the reaction, while Re and V remained highly dispersed over the support. C mapping was uniform for the entire image (including areas where no samples were present), indicating that the carbon was associated with the STEM sample grid. This suggested that the steam reforming reaction did not lead to significant carbon deposition on the sample surface. Unlike the unmodified nickel aluminate, substantially no carbon filaments were observed in the Re, V-promoted catalyst after reaction, as shown in the micrographs in FIG. 25. The only structural change detected in the Re, V-promoted catalyst after reaction was a minor increase in grain size.

To demonstrate the ability of vanadium at improving carbon gasification, temperature-programmed coking and gasification were performed. The same amount of coke (1 g/g) was allowed to form on the reduced catalysts without promoter, with Re promoter and with Re and V promoters at 600° C. over time. Following the coking process, coke gasification was undertaken with various concentrations of H₂O in N₂ at 100° C.-800° C. (ramp=0.8° C./min). The catalysts were then oxidized in air to determine the coke remaining on the catalyst surface. The graph in FIG. 26 shows that a low H₂O concentration in N₂ (5%) was sufficient to gasify most of the coke on 2 wt % Re,2 wt % V-promoted nickel aluminate. A large amount of coke was left on the surface of 1 wt % Re-promoted and unmodified nickel aluminate even after gasification with a high H₂O concentration in N₂ (20%). This confirmed that V favors the gasification of carbon.

In summary, metal promoters were introduced to the optimized nickel aluminate system (Ni/Al=1.10) for propane steam reforming to further improve the catalytic activity and coke resistance. The catalytic activity and H₂ yield were increased with the addition of selected metals, in the order of Re>Rh>Pt>Ir>Pd>vapor-grafted Ru>Ru>V. Of the catalysts studied, the catalyst promoted with Re showed the highest reducibility and active surface area, and it enhanced the low-temperature catalytic activity most significantly. For some embodiments, the optimal Re loading was 1 wt %. The use of Re-promoted catalyst led to higher reaction rates compared to unmodified nickel aluminate at various temperatures due to its higher metal dispersion. This advantage was particularly noticeable at low calcination and pretreatment temperatures. Metal additives of promoters were also examined for improving the coke resistance of nickel aluminate. Coking was dramatically reduced with the addition of V, Mo and W. V showed a positive instead of negative impact on the catalytic activity of nickel aluminate.

To derive a steam reforming catalyst with both excellent catalytic activity and coke resistance, Re and V promoters were both introduced to nickel aluminate. For some cases, the optimal combination involved 2 wt % Re and 2 wt % V, which provided higher catalytic activity and H₂ yield than unmodified, Re-promoted, and V-promoted nickel aluminates in propane steam reforming at a low H₂O/C ratio of 1:1. This could be attributed to the high reducibility and improved carbon gasification of Re, V-promoted catalyst due to Re addition and V introduction, respectively. The superb coke resistance and catalyst stability of the Re, V-promoted system was also demonstrated.

The examples described herein illustrated the successful tailoring of nanocomposite catalysts for the effective steam reforming of propane. The synergistic effects between the complex oxide support and the two metallic promoters in attaining high catalytic activity, selectivity, deactivation resistance and thermal/hydrothermal stability may be extended towards the design of catalytic systems for other industrial processes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of and “consisting essentially of shall be closed or semi-closed transitional phrases, respectively, as set forth in the United States Patent Office Manual of Patent Examining Procedures, Section 2111.03.

What is claimed:

1. A catalyst system for steam reforming, comprising:
a reaction chamber constructed and arranged to be exposed to a source of reactant gas, the reaction chamber comprising a catalyst composition for catalyzing a reaction involving the reactant gas,
the catalyst composition comprising a nickel aluminate material and a metal additive, wherein the ratio of nickel to metal additive is greater than 2.5:1, by weight.

2. A catalyst system as in claim 1, wherein the metal additive is not Ru.

3. A catalyst system as in claim 1, wherein the metal additive is Re, V, Rh, Pt, Ir, Pd, Fe, La, Co, Mn, Os, Sr, Ce, Ta, Mo, Cr, Au, Sm, Nb, Cu, W, Sn, Ag, or a combination thereof.

4. A catalyst system as in claim 1, wherein the metal additive is Re, V, Rh, Pt, Ir, Pd, Fe, La, Co, Mn, Os, Sr, Ce, or a combination thereof.

5. A catalyst system as in claim 1, wherein the metal additive is Re, V, Rh, Pt, Ir, Pd, or a combination thereof

6. A catalyst system as in claim 1 , wherein the metal additive comprises Re.

7. A catalyst system as in claim 1, wherein the metal additive comprises V.

8. A catalyst system as in claim 1, wherein the metal additive comprises Re and V.

9.-13. (canceled)

14. A catalyst system as in claim 1, wherein the nickel aluminate material has a nickel to aluminum molar ratio greater than 0.96:1.

15.-20. (canceled)

21. A catalyst system as in claim 1 , wherein the nickel aluminate material has a nickel to aluminum molar ratio of 1.1:1.

22. A catalyst system as in claim 1 , wherein the reactant gas is a hydrocarbon.

23. A catalyst system as in claim 1 , wherein the reactant gas is methane or propane.

24. A catalyst system as in claim 1, wherein the reactant gas is propane.

25. A fuel cell comprising a catalyst system as in claim 1.

26. A catalyst system for steam reforming, comprising:
a reaction chamber constructed and arranged to be exposed to a source of reactant gas, the reaction chamber comprising a catalyst composition for catalyzing a reaction involving the reactant gas,
the catalyst composition comprising a nickel aluminate material and a metal additive, wherein the molar ratio of nickel to aluminum is greater than 0.96:1.

27.-39. (canceled)

40. A catalyst system as in claim 26, wherein the nickel aluminate material has a nickel'1 to aluminum molar ratio of 1.1:1.

41.-44. (canceled)

45. A method comprising:
contacting a reactant gas with a catalyst composition comprising a nickel aluminate material, wherein the contacting takes place at less than 500° C.; and
allowing the reactant gas to undergo a chemical reaction with the catalytic material to produce a desired product,
wherein at least 75.0% of the reactant gas undergoes the chemical reaction.

46. A method as in claim 45, wherein the catalyst composition further comprises a metal additive.

47.-62. (canceled)

63. A method as in claim 45, wherein the desired product is hydrogen.

64.-72. (canceled)

73. A method as in claim 45, wherein the contacting takes place at a temperature of at least 400° C.

74. A method comprising:
contacting a reactant gas with a catalyst composition comprising a nickel aluminate material and a metal additive, wherein the ratio of nickel to metal additive is greater than 2.5:1, by weight, or, wherein the molar ratio of nickel to aluminum is greater than 0.96:1; and
allowing the reactant gas to undergo a chemical reaction with the catalytic material to produce a desired product.

75.-84. (canceled)
